(19) United States
(12) Patent Application Publication
(10) Pub. No.: US 2025/0078607 A1
(43) Pub. Date: Mar. 6, 2025

(54) Skill Game

(71) Applicant: Savvy Dog Systems, LLC, Duluth, GA (US)

(72) Inventors: Brock Smith, Duluth, GA (US); Glen Carter, Duluth, GA (US)

(21) Appl. No.: 18/819,327

(22) Filed: Aug. 29, 2024

Related U.S. Application Data
(60) Provisional application No. 63/535,923, filed on Aug. 31, 2023.

(51) Int. Cl. G07F 17/32

(52) U.S. Cl. CPC G07F 17/3213; G07F 17/323; G07F 17/3262; G07F 17/3295

(57) ABSTRACT

Systems and methods to generate and enable use of a skill game. An embodiment of a system can include a processor and a computer-readable storage medium, coupled with the processor, comprising instructions. Upon input from a player, the instructions, when executed by the processor, can initiate play of the skill game, which can include an array of cells having a series of symbols displayed in a presentation order in the array of cells. The player must exercise skill to move at least one of the displayed symbols to a different cell to complete a sequence or pattern of symbols. The instructions will then determine a game outcome of the second play of the skill game, based on a position of the relocated system in relate to a position of each corresponding symbol in the player created sequence of symbols.

### CROSS-REFERENCE TO RELATED APPLICATION

The present application claims priority to U.S. Provisional Patent Application No. 65/535,923, filed Aug. 31, 2023, entitled “SKILL GAME,” the disclosure of which is incorporated herein by reference in its entirety.

### FIELD OF DISCLOSURE

The present disclosure is generally directed to gaming systems and, in particular, toward gaming systems that enable sliding symbol operations for skill games.

### BACKGROUND

Gaming machines that offer random-based gambling games or games of chance are prohibited or even illegal in many jurisdictions. Some skills based games do not allow players to win certain amounts, such as, more than the money a player has spent or more than any other player regardless of skill.

### SUMMARY

Accordingly, Applicant has recognized a need for systems and methods for enabling a gaming machine to provide a skill-based, sliding or moveable symbol operation for games, such as electronic grid-based games. Such gaming machines can offer a number of built-in game play features that contribute to the overall player experience. Any type of game play feature that presents the player with an additional opportunity to win is often viewed as desirable and can lead to increased play of the gaming machine

In certain embodiments, the present disclosure relates to a device, method, and system that provide sliding or moveable symbol operations for skill games, which, in embodiments, can include grid-based (e.g., reel-spin, drag and move, and/or matching) gaming devices. In some embodiments, a gaming device is provided. The gaming device can comprise a display device; a processor coupled to the display device; and a memory coupled with and readable by the processor and storing therein instructions that, when executed by the processor, cause the processor to execute operations or instructions. The operations or instructions, when executed, can include receiving a first input from a player interacting with the gaming device initiating a first play of a skill game. In an embodiment, the first play or first input can include entry of a command or an indication to start or begin the skill game or a round or play of the skill game (e.g., the player can push a button, etc.).

In embodiments, the game can include a field that can be arranged as an array of cells (e.g., a grid) having a presentation order defining a specific position of each cell in the array of cells relative to one another. The operations or instructions, when executed, can include rendering, by the display device in response to receiving the first input, a first sequence of symbols can be presented, which can, in embodiments, comprise an array of cells, with each cell in the array of cells comprising a discrete symbol in the first sequence of symbols. The operations or instructions, when executed, can include receiving a symbol movement input from the player interacting with the gaming device by dragging a particular symbol in the rendered first sequence of symbols from a first cell in the array of cells to a second cell in the array of cells.

In addition, in embodiments, the operations or instructions, when executed, can include receiving a second input from the player interacting with the gaming device that initiates a second play of the skill game. The operations or instructions, when executed, can include rendering, in response to receiving the second input, a second sequence of symbols within the array of cells. In an embodiment, the second input can include an indication to start or begin a next skill game or another or second round or play of the game. The operations or instructions, when executed, can include determining, based on a position of the particular symbol and a position of each symbol in the first or second sequence (and, in other embodiments, subsequent sequences) of symbols relative to the presentation order, a game outcome of the second play of the skill game.

In some embodiments, a method is provided. The method can include receiving, by a processor of a gaming device, a first input from a player interacting with the gaming device initiating a first play of a skill game, the skill game arranged as an array of cells having a presentation order defining a specific position of each cell in the array of cells relative to one another. The method can include rendering, by a display device of the gaming device in response to receiving the first input, a first sequence of symbols is populated into the array of cells, each cell in the array of cells comprising a discrete symbol in the first sequence of symbols. The method can include receiving, via a user interface of the gaming device, a symbol movement input from the player interacting with the gaming device and dragging a particular symbol in the rendered first sequence of symbols from a first cell in the array of cells to a second cell in the array of cells.

In some embodiments, a previous symbol in the second cell can be moved and/or rendered in the first cell, while the particular symbol can be moved and/or rendered in the second cell. The method can include determining, by the processor of the gaming device based on a position of the particular symbol and a position of each other symbol in the first sequence of symbols relative to the presentation order, a game outcome of the first play of the skill game. In embodiments, the method also can include receiving, via the user interface of the gaming device, a second input from the player interacting with the gaming device that initiates a second play of the skill game. The method can include rendering, by the display device of the gaming device in response to receiving the second input, a second sequence of symbols populated into the array of cells. In another embodiment, the method can include receiving input from further player interaction, such an interaction including moving a second particular symbol in the second sequence of symbols. The method can also include determining, by the processor of the gaming device based on a position of the second particular symbol and a position of each symbol in the second sequence of symbols relative to the presentation order, a game outcome of the second play of the skill game.

In some embodiments, a system is provided. The system can include a processor and a computer-readable storage medium, coupled with the processor, comprising instructions that are executable by the processor. The instructions, when executed, can comprise instructions that initiate a first play of a game. In some example embodiments, the skill game can comprise a grid-based game that can include a game field arranged as an array of cells having a presentation order defining a specific position of each cell in the array of cells relative to one another. The instructions, when executed, can comprise instructions that, in response to receiving the first input, cause a first sequence of symbols to be rendered in an array of cells, each cell in the array of cells comprising a discrete symbol in the first sequence of symbols. The instructions, when executed, can comprise instructions that receive a symbol movement input dragging a particular symbol in the rendered first sequence of symbols from a first cell in the array of cells to a second cell in the array of cells. The instructions, when executed, can comprise instructions that, based on a position of the particular symbol and a position of each symbol in the first sequence of symbols relative to the presentation order, determine a game outcome of the first play of the skill game.

Still other aspects and advantages of these embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIG. 1A depicts one example embodiment of a computational gaming device for enabling enhanced gaming features and sliding symbol operations in accordance with the principles of the present disclosure;

FIG. 1B depicts another example of a computational gaming device for enabling enhanced gaming features and sliding symbol operations in accordance with the principles of the present disclosure;

FIG. 2 is a block diagram depicting an embodiment of components of a computational gaming device for enabling enhanced gaming features and sliding symbol operations in accordance with the principles of the present disclosure;

FIG. 3A shows an example embodiment of an illustrative layout of symbols rendered to an array of cells of a skill game in accordance with the principles of the present disclosure;

FIG. 3B-3C show examples of pay-line layouts and a pay table for the skill game of FIG. 3A.

FIG. 4A illustrates an example embodiment of a first output of the computational gaming device showing a first sequence of symbols comprising a slidable symbol feature associated with a particular symbol in the array of cells that are rendered as a result of a play of the skill game in accordance with the principles of the present disclosure;

FIG. 4B illustrates an example embodiment of a subsequent output of the computational gaming device showing movement options for the particular symbol along lines of the array of cells in accordance with the principles of the present disclosure, and particularly exemplarily showing a slidable symbol being moved (e.g., slid, dragged) from the cell 312 at the intersection of the second row 308b and the fourth column 116d (e.g., the position shown in FIG. 4A) to the cell 312 at the intersection of the second row 308b and the third column 116c;

FIG. 4C illustrates an example embodiment of an output of the computational gaming device showing multiple slidable symbols that are configurable to be re-arranged, slide, or dragged to generate at least one column with three matching symbols in a column or to generate at least one row with five matching symbols in accordance with the principles of the present disclosure;

FIG. 4D illustrates an example embodiment of a subsequent output of the computational gaming device showing the particular slidable symbol when the slidable symbol has been dragged to the appropriate cells or positions and showing that, when a slidable symbol has been dragged from one cell 312 to another, the type of the symbol 318 associated with the slidable symbol remains the same as when it first appeared for at least one subsequent paid-for play. Further shown is an exemplary position, by continuing the sliding movement input provided by the player, of the slidable symbol when the slidable symbol has been dragged to cells corresponding to two completed columns.

FIGS. 4E-4F illustrate example embodiment of an output of the computational gaming device after the player selects to play for a higher reward or higher wager of credits, showing a timer that is correspondingly adjusted (e.g., dropped to 14 seconds as shown in FIG. 4E, from an exemplary initial time timer setting of 20 seconds as shown in FIG. 4A). If the player exercises skill and solves the game within the shortened time, they can win a higher reward (e.g., 1000 credits as indicated in FIG. 4F).

FIG. 5 illustrates an example embodiment of a further output of the computational gaming device showing a pop-up window comprising subsequent play information for a bonus round play in accordance with the principles of the present disclosure;

FIG. 6 is a flow diagram of an example process for enabling a sliding symbol operation in a skill game in accordance with the principles of the present disclosure; and

FIG. 7 is a flow diagram of an example process for determining subsequent play information associated with performing a sliding symbol operation in the skill game in accordance with the principles of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a cell” can include two or more such cells unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinary term) to distinguish claim elements.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Embodiments of the present disclosure are directed to an amusement or gaming system or machine that facilitates play of skill-based, electronic game(s) that allow players to spend money and win awards including money, prizes, credits, or other rewards by exercise of skill, including winning awards greater than a player's amount spent through the exercise of such skill. Effectively, a player's ability to win a prize or award is dependent on their exercise of skill, for example, learning and executing rules, patterns, and other features of the game as opposed to random chance or “blind luck.”

For purposes of illustration, and not limitation, embodiments of the amusement system of the present disclosure will be described in connection with amusement systems or devices that can be configured to provide one or more skill games that can incorporate a sliding symbol or touch and drag operation. For example, a player during play of a game can select and move one or more symbols (such as, for example, characters, icons, or other indicia) from one location on a game field to another location on the game field to solve and win the game. Movement of the particular symbol from one cell to another allows a player to exercise a level of skill to generate winning sequences of symbols to win the game being played. During each play of a selected skill game, a play time can be generated based on various factors (for example, difficulty, potential winning amount, and/or symbols currently on the game field, among other factors). The duration of each play can be the total allotted play time for a game. In other words, a player has the duration of the play time to move the symbols to a winning position or alignment. In some embodiments, the skill game can be configured to enable multiple plays, e.g., multiple successive puzzles or a bonus game can be permitted within the allotted play time based on player skill and/or a selected wager or game feature.

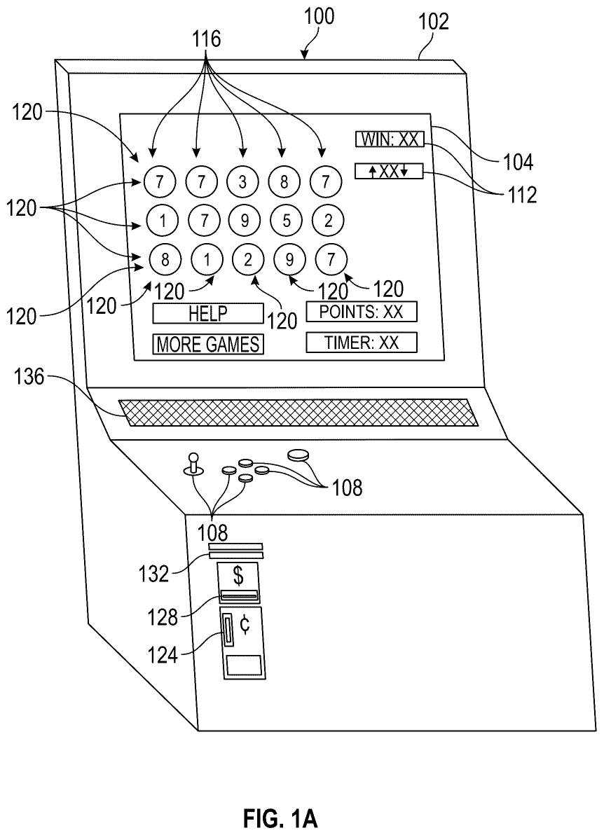

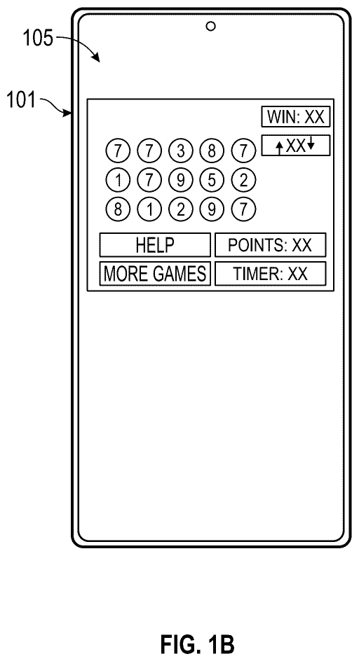

In embodiments, as illustrated in FIGS. 1A through 7, the amusement system can comprise an electronic skill game, that implements slidable or moveable symbols and subsequent play operation. For example, in embodiments, the amusement system can include a gaming cabinet or housing that supports a display (for example, a flat panel display or monitor) with a screen for display of one or more game fields and/or images and for supporting play of one or more skill games. In embodiments, the display can comprise a touch screen having on-screen player controls that enable a player to touch and drag selected symbols across the screen during play. In some embodiments, the gaming cabinet further can include other types of game or player controls (for example, buttons, joysticks, directional pads, and/or levers, among other types of player controls) that allow individual users players to play different types of skill game(s) and control and/or select various corresponding gaming elements or features shown on the display. In addition to controlling play of games, the player controls can be used to control and/or select other functions of the games. For example, buttons, icons, symbols, and so on can be provided to enable players to change the amount of cost or credit used per play. For example, players can cycle or toggle through a predefined list(s) of play costs shown on the playfield to set amounts for each player directed object. Still further, the player controls can include buttons such as a menu/change game button to enable the player to exit and/or change the displayed game, or to open or otherwise initiate a “Menu” or “Help Screen” and/or other informational features of the amusement system.

The gaming cabinet further can include one or more monetary interface peripherals (for example, a bill acceptor, printer, and/or other similar peripherals). The bill acceptor can accept valid notes of currency, such as bills or coins, that are converted to credits at the individual player stations. The printer can provide printouts, receipts, and/or vouchers that record or provide payment or payout information, prize redemption tickets, as well as other suitable information, such as audit conformation and reports.

In addition, the gaming cabinet also can include audio and lighting features/elements (for example, speakers or other audio producing transducers and LED lighting elements, and/or lightbulbs, among other elements) that provide various audio, visual, tactile or other effects in concert with or otherwise corresponding to game play. In some embodiments, the gaming cabinet further can include an optional, secondary video display (such as, a light up display or a video display, including, for example, a liquid crystal display (“LCD”), a cathode ray tube (“CRT”) display, a light emitting diode (“LED”) display, and/or a plasma display) provided therealong, such as along an upper or top portion or area of the gaming cabinets. The secondary display can show any combination of game information, ancillary information, or other related information to the players, such as player information, bonus information, advertisements, and/or selectable game options.

It will further be understood that, while embodiments of the present disclosure can be described in connection with the example of a single player cabinet game or touch screen type gaming device for play of skill games with sliding symbol operations, it should be appreciated that embodiments of the present disclosure are not so limited. For instance, other types of computational devices, such as portable user devices, smartphones, tablets, laptops, Personal Computers (PCs), and/or wearable devices can be used to implement game enhancement features as part of a game as described herein. Furthermore, it should be appreciated that embodiments of the present disclosure can apply to games other than skill-based, slidable or movable symbol based games. For instance, and not limitation, embodiments of the present disclosure can be used in connection with any type of grid-based skill game such as bingo, keno, slots, other types of matching games, and/or table games.

In one embodiment, the amusement system can include a centralized or host control system having one or more processors (for example, microprocessors, CPUs, and/or other processors) that is in communication with the individually connectable or linkable player stations, which each can have their own player station control systems, with one or more processors in communication with the centralized control system. The player station control systems communicate or cooperate with the centralized control system to send and receive instructions, feedback, workflows, and/or signals to facilitate game play and other functions of the amusement system. Each of the player station control systems generally controls and provides processing of one or more actions of its corresponding game controls and monetary interface peripherals, as well as the audio and lighting features of the player station. The player station controls also can provide tactile or haptic feedback during game play.

The centralized control system and the player station control systems access, run, and coordinate action of one or more actions or components of a gaming platform that provide for play of one or more skill-based games with the amusement system. The amusement system further will include or provide skill-based games with prescribed operations or patterns incorporating a series of learnable skill applications/features, operable without the use of Random Number Generators (RNGs) or other randomized, compensation algorithms, and/or automatic awards algorithms that introduce “chance” into the game or otherwise limit the player's exercise of skill or ability to win a game. For example, the games can include an environment of changing screens, colors, characters, elements, and/or features which can provide the appearance/randomness of randomness, but also include rules and identifiable patterns that a player can learn or strategize against to develop their skill and ability at playing the game to consistently attain awards greater than the amount the player has spent (or a greater than 100% Return to Player (“RTP”)).

The centralized control system can include one or more processors (including microprocessors, CPUs, and/or other processors), and one or more memories (including ROM, RAM, and/or other non-volatile memories) that store instructions, including game rules and/or instructions and other programming, that when accessed and executed by the one or more processors facilitate game play and other operations/functions of the amusement system.

In one example embodiment, the centralized control system includes a centralized PC system controller with at least one processor and a memory; however, other suitable computing hardware can be used without departing from the scope of the present disclosure. The centralized control system further can include a graphics adapter, or a connector configured to accept a graphics card. Still further, the centralized control system can include one or more hubs, such as one or more USB port hubs that connect to one or more controllers of a motherboard of the player station control systems 64.

In one embodiment, the gaming platform can provide a video playfield on the display of the gaming cabinet. The playfield can be used by one or more players (e.g., by accessing the controls of a corresponding player station) to compete for awards or prizes that are made available over time. The awards or prizes can include or otherwise be associated with one or more symbols or sets of symbols (e.g., graphic icons, characters, numbers, and/or other symbols) each arranged in a grid-style pattern that allow players to move one or more of the symbols, characters, and/or numbers in one of the sets corresponding to the player in a row or column within a limited time frame. Such actions include a plurality of repetitive motions and/or pattern recognition that can be learned, recognized and anticipated by player skill and experience.

In embodiments, the symbols further can have differing appearances, values, and difficulty levels of attainment. Generally, a selected time frame and/or distance to generate a matching row or column, which can create a more difficult to obtain matching row or column, can have a higher potential award or prize values. In one variation, derivations in size of different symbol types can be used as lower-value and higher-value types of symbols. In other variations, sequentially increasing numbers and/or letters can be utilized as lower-value and higher-value. As a result, the skill of the players (e.g., their decision making, ability to take certain actions quickly, ability to recognize and/or learn patterns, learn and/or memorize game instructions or rules) and their knowledge of the conditions of the game will determine immediate and long-term outcomes (e.g., awards, prizes, winnings, and/or bonus pools). Therefore, it is possible for skilled players to attain outcomes/award values that result in a consistently greater than 100% RTP over time, and with outcomes based on chance and/or which are predetermined being substantially eliminated.

The amusement system also includes one or more gaming platforms or gaming programs that include programming or instructions for one or more skill-based games. The gaming platform can include computer programs instructions, workflows, and/or code that are accessed and executed by the processors to facilitate play of the one or more skill-based games with the amusement system. In additional or alternative constructions, however, the gaming platform(s)/program(s) can be accesses and/or run on one or more personal electronic devices, such as smart phones, tablets, personal computers, and/or other mobile electronic devices, to facilitate play of the one or more skill-based games on the personal electronic devices. In one embodiment, the personal electronic devices can be provided at a facility (for example, amusement center, gas station, grocery store, airport, and/or other similar locations) and accessed by users for play of the one or more skill-based games, and in other embodiments, users can access and/or download the gaming platform(s)/programs (such as from an application store, for example, Apple Store®, Google Play® store, and/or from an available public or private network) to their own personal electronic devices for play of the one or more skill-based games therewith. In the embodiments employing personal electronic devices, the player controls can be provided as selectable icons or areas shown on the display of the personal electronic devices and/or can include physical controls of the devices themselves and/or remote controls in communication therewith.

The gaming platform generally can provide one or more substantially true skill-based games that do not utilize a Random Number Generator (RNG) and/or compensating algorithms, such as can be common with many slot-style games and other “games of chance.” That is, players generally control decisions on whether or not to take specific actions (for example, direct objects, initiate game plays, set play costs, and/or make selections, among other actions) at any particular time and player skill abilities and/or player strategy determine immediate and long-term outcomes. In embodiments, no aspects of the skill game that affects the ability of a player to win/solve the game and to be awarded an award or prize are RNG driven, and no background code runs (for example, compensation algorithms) that calculate and/or artificially limit the return to a player and/or make it difficult for players to attain awards or prizes regardless of their skills. The gaming platform generally includes programming requiring interaction and the application of player skill and/or strategy to obtain awards or prizes.

For example, one or more skill-based games use multiple screens or multiple elements and/or features provided on the display of the amusement system to give the appearance of chance or randomness, though the screens, features, and/or elements are not provided at random, and instead are provided according to prescribed or predetermined patterns or with specific tendencies that can be learned or memorized by players such that players can win based on their individual skill. That is, all choreography, awards/prizes, and/or odds of attainment are deterministic, predictable, and/or pattern-based for potential memorization and/or anticipation by players. In some variations, help text can be provided to players within the game's help screens (for example, accessed via the menu button) to help players understand the game and/or develop strategies. As a result, players are able to use skill to win more than spent over time (in other words, players can have more than 100% return to player percentage (“RTP”) over time). Return to player generally includes an amount awarded to a player over an amount or value spent by the player towards the award. That is, an amount or value expended by the player to obtain the award. In this regard, by understanding the rules and game operations and using strategies and tools available during gameplay, it is possible for players to attain awards or prize values, by exercising of skill, that result in a consistently greater than 100% RTP over time.

In an embodiment, the array or arrangement of symbols or elements displayed within the game filed by the amusement system can appear to be randomly generated. If no winning combination is possible based on this initial play (and/or, in another embodiment, if a player selects an element or button indicating new generation of the elements), then the amusement system can, for the same play, generate a new arrangement of symbols or elements (in other words, a player can continue to generate new play fields or arrangements of symbols or elements, at least for the time set to win the game or play or solve a puzzle).

In an embodiment, the amusement system can include sub-games defined by a series of game instructions or rules stored in the memory and accessible by players at the player stations; receive a cost for a play of the skill-based game from one or more active player stations; receive one or more gameplay input signals from one or more player controls of an active player station, and in response, directing one or more objects along the playfield or, in particular, a grid-style playfield; and if one or more objects are aligned in a row or column, initiate a sub or meta-game associated with the one or more symbols and determine whether one or more of the active player station has obtained an award based on game rules or instructions related to the sub or meta-game associated with the one or more symbols. Players at the player stations can use strategy or skill to direct objects at select ones of the plurality of symbols to achieve a return to the player greater than 100%.

The game(s) can include several symbol types, with derivations in size, color, and/or appearance and/or a time or timer based on lower-value symbols and higher-value symbols (for example, some symbols, if those symbols include a potential match or alignment, can generate an increase or decrease in time for a player or user to make a match or alignment).

For example, in embodiments where the symbols or objects include sequentially numbered symbols, such as numbered billiard balls, up to a selected number, the difficulty, and thus the value or amount winnable by a player, can be determined based on the highest numbered billiard balls displayed on the table that could be aligned in a column or row and/or based on the amount of time available to align a set of billiard balls in a column or row. In such embodiments, the amount of time available to make a match or alignment can also be based on the highest numbered billiard balls displayed on the table that could be aligned in a column or row.

In addition, while an example embodiment of the skill game is discussed and shown in the figures using a game filed having billiard balls as the symbols shown on the game field or array, it will be understood that such an example is non-limiting, and, rather than billiard balls, other symbols or objects can be utilized, such as, for example, numbers, letters, and/or other objects or symbols (for example, rubber ducks, animals, different types of candy or fruit, and/or other various objects) or symbols. Still further, in some embodiments, the symbols can be provided with different effects, such as flashing colors, changing size, highlighting or shadowing, and/or other animation effects, e.g., ducks flying, fruit peeling, etc.,

In exemplary embodiments, the games displayed/presented by the amusement system can include grid-type games, which can include various arrays of rows and columns. For example, such games can include a 3×5, 4×5, 4×4, 5×5, 4×6, 5×5, 5×6, 6×6, and/or other varying size configurations of rows and columns.

During regular play, a “slidable symbol” can be rendered to any cell in the array of cells of the grid-based skill game. The slidable symbol can be a particular symbol in a sequence of symbols that is part of an array of cells, where the particular symbol is associated with a sliding symbol feature or operation. In some embodiments, an identifying mark (e.g., a crosshair type of symbol, highlight, underscore, and/or star) can be rendered along with the slidable symbol (e.g., via a display screen of the gaming device). The identifying mark can indicate that the player can drag, or slide, the slidable symbol from one cell to another, in any direction, in the array of cells to maintained in that “dragged-to” cell, or position, for a subsequent play of the grid-based skill game.

In other embodiments, all symbols rendered in each of the cells in the array of cells of the grid-based skill game can be slidable or moveable. Further, an identifying mark, or, in some embodiments, animation effects such as flashing colors, movement of characters, etc., can be utilized. For example, a “hint” or clue feature can be provided (e.g., a button on the console or screen of the game), which, if engaged by the player, can be provided with a hint or clue for solving the game, such as flashing colors, animation effects, etc., that indicate which symbols can provide a winning combination. In some embodiments, e.g., if a player selects to receive a hint, and/or if a selected amount of time for the game or play has elapsed, the identifying mark or other indicator, can indicate a particular play or move that can result in a win, a partial win, or a move that places a symbol closer to a winning or partial winning position.

In some embodiments, the slidable symbol operation can determine a bet amount placed by a player and, based on the bet amount, determine a number of plays are available, or offered, to the player. The number of plays can increase when the bet amount is above a predetermined threshold. Additionally, or alternatively, the number of plays can decrease when the bet amount falls below the predetermined threshold. In another embodiment, identifying mark can be removed or disabled for higher bets or can be removed by a player to increase a potential amount won.

In any event, the player can have the ability and choice as to where any of the displayed symbols should be dragged during play of the skill game, and further, can have the ability to move/slide multiple symbols across the grid or array using multiple moves to create a winning combination. In some embodiments, the use of the timer can limit the movements of the symbols, e.g., the shorter the time allotted to win the game, the less moves the player make be able to make, thus requiring greater skill to win the game. In other embodiments, the number of symbols that can be moved and/or movements allowed can depend on whether the player wishes to increase their chances of winning, increase their payout amount for a winning sequence of symbols, increase the number of plays that the slidable symbol is maintained in the dragged-to cell, and/or combinations thereof, e.g., playing for a higher value prize can require the player to exercise greater skill to solve the game by recognizing the proper symbols to move and moving the symbols into a winning configuration within a shorter number of moves.

In addition, in one embodiment, moving the symbols farther from a higher priority position, or to a lower priority position, in the skill game (for example, farther away from its initial cell in the game field) can increase the volatility of the game by, for instance, making it harder to win but allowing the player to win more (for example, an increased payout amount) in the event of a win. Additionally, or alternatively, moving the symbols to a higher priority position in the skill game (for example, closer to, or in, the cell corresponding to the first reel in a slots and/or reel-spin game) can increase the chances of winning but decrease the payout amount in the event of a win.

In some embodiments, the slidable symbol can be moved along a line to any cell in the array of cells, along the line, and can be a part of a sequence of symbols that win along a single payline and/or along multiple paylines. In another embodiment, the player can have the ability to move any of the symbols from one cell to another. Such an ability can include moving a symbol to adjacent cells, to diagonally adjacent cells, horizontally adjacent cells, vertically adjacent cells, or to any cell in the array of cells. Further, when a player moves a symbol to a symbol occupied cell, the current symbol in the symbol occupied cell can be moved to the cell where the moved symbol originated.

The skill-based amusement system can determine an award for obtainment of a particular matched set or arrangement of a particular symbol within the grid or array of the game being played based on an amount of time remaining on a timer associated with the symbol and/or based on the type of symbol matched (for example, a match of higher value symbols can award more than a match of lower value symbols). In embodiments, the time allotted on the timer can be varied based on a value of the prize(s) to be awarded if the player wins the game. In addition, in embodiments, the game can be configured to permit or provide multiple winning combinations. For example, the skill game can be programmed to allow a player to select tiers, amounts/values, and/or a multiplier of a value they want to play for, and the timer can be adjusted based on such a selection. In embodiments, the higher the tier or value to be won, the less time.

In alternative embodiments, the timer can be replaced with a counter that is not necessarily tied to a specific time increment. For example, in some instances, the counter can correlate to 1 second or more, and each count can be substantially the same increment; while in other cases, the count can be less than 1 second, e.g., where a player selects a higher tier or value, and/or in some embodiments, the time increments per count can get successively smaller as the game progresses, requiring greater skill to win.

As indicated in the Figures, the skill game generally requires a player to exercise some level of skill or thought to move certain symbols to an aligned or matched configuration. In embodiments, the skill game further provides the player with multiple opportunities to win by forming and/or creating greater numbers of matching symbols in alignment along a row or column or diagonally. Depending on how many symbols the player can match within an allotted time and how they align the correct matching symbols, the player can create more than one a winning combination, with different combinations having different values, e.g., lining up 4 “7” balls in 1 row can provide a higher value than 3 “4” balls in a column, but less than a diagonal alignment of then same or different balls. Still further, in some embodiments, if the allotted time on the timer has not expired, the game can continue even if a “winning combination” has been achieved, if the best (e.g., the highest value) winning combination has not been made. Thus, in embodiments, simply because the player makes a winning combination, if that is not the “best” or highest value winning combination, can continue, giving the player the ability to continuing playing to find a better or the best winning combination. In such instances, the game also could be configured to generate an indicator to tell the player there is a higher value combination that still can be made before the time expires.

Still further, in some embodiments, the skill game can include a “hint” or “clue” feature. For example, the skill game can have a button or icon along the console or shown on the screen of the amusement system that, when engaged by the player, causes the processor to execute programming or instructions adapted to provide the player with an indicator or hint/clue to help them solve and win the game. In embodiments, such an indicator or hint can include animations or other effects, such as highlighting certain symbols that can form a winning combination, changing colors or sizes, or other effects. By way of example, for games that can have a greater level of difficulty, such as a game with a series of symbols generated as characters such as different ducks, the ducks can have different movements, such as flapping wings, flying, winking, etc. Activating such an indicator or indicators can provide the player with a visual clue or hint to help them in determining a winning combination.

In embodiments, such a hint or clue function can be player generated/initiated. In other embodiments, in addition or as an alternative to the player initiating the hint or clue function, this function can be generated automatically. For example, if the remaining time for the play and completion of the game reaches a certain threshold and the player hasn't made a winning combination, a hint or clue can be provided to the player.

The slidable symbol can correspond to any symbol in the skill game being player, and can be adapted to move in multiple directions, and across multiple moves from one cell to another cell in the array of cells of the skill game. The slidable symbol, as used herein, can be an any symbol (for example, normal symbol, wild symbol, bonus symbol, and/or multiplier) used in the skill game. The term “slidable symbol,” and variations thereof, as used herein can refer to any symbol of the skill game that is identified as having the ability to be moved (for example, by a player) from one cell to another cell in the array of cells for a subsequent play of the skill game. The number of slidable symbols in any skill game can include all the symbols in an array of cells, one symbol in the array of cells, or a subset of the symbols in the array of cells. In addition, in embodiments, the number of moves and directions of movement (e.g., along rows, columns or diagonally) cannot be limited.

By way of example, the slidable symbol in an electronic reel-spin, or slots, game can correspond to a symbol used in the electronic reel-spin game such as a “seven” symbol, a “fruit” symbol, a “BAR” symbol, a “diamond” symbol, a “gem symbol,” a “multiplier” symbol, and/or some other symbol used in the electronic reel-spin game. Continuing this example, when a player spins the reels of the electronic reel-spin game the amusement system can assign these symbols to various cells of the array of cells. With the appearance of the different symbols in the array generally changing from game to game, and further generally giving an appearance of being randomly arranged In the reel-spin game example, a “cherry” can be defined (for example, by the rules of the reel-spin game) as a winning symbol when found in a first position of the presentation order of the array of cells.

In some embodiments, the rules of the reel-spin game can define game outcomes for symbol types, symbol types in particular sequences or orders, symbol types in particular cells in the presentation order of the array of cells, and/or the like. If the slidable symbol is a “cherry” disposed in the final position (for example, the lowest priority position) of a sequence of symbols in the presentation order of the array of cells, the player can select to move the slidable symbol represented by the cherry to the first position (for example, the highest priority position) for the next play to greatly increase the possibilities of a win in accordance with the rules. In other examples, no symbols can be maintained from one play to the next. In other words, if a player is able to and does make a match within a time frame, then the player wins, otherwise the player can select a “play” or “next play” button to progress to the next match or puzzle.

Movement of the slidable symbol can be restricted along a line running through the cell in which the slidable symbol first appeared. In one embodiment, movement of the slidable symbol can be restricted to slide along cells in full rows, full columns, and/or full diagonal lines in the array of cells. The term “full,” as used herein, can refer to total number of cells required to produce a sequence of symbols that comport with rules of the skill game and produce a game outcome. For example, a skill game having a game field arranged as a reel-spin game (for example, slots game) having four separate reels can require four cells, each containing a symbol or an absence of a symbol, to align along a payline to identify the sequence of symbols that produces a particular game outcome. In this example, a total number of four cells arranged along the payline (for example, a line) comprise the full row that produces the game outcome of the reel-spin game. In other examples, the symbol can be dragged to any position or can be dragged to one position at a time, each movement taking a preselected amount of time.

The sliding symbol operations and associated features can be activated, as described herein, during play of a skill game, after a play of the skill game, and/or prior to a play of the skill game. As mentioned above, this sliding symbol operation can be made available within the context of a slot game, a matching game, a bingo game, a keno game, a poker machine, or in any other skill game of chance that awards particular symbol combinations relative to positions on a user interface.

Among other things, embodiments of the present disclosure provide a player with more ways to win a game, the ability to alter the chances of winning in a game, the ability to alter the payout amount for a winning game outcome (for example, through a bonus round or match), and add excitement to the overall game-playing experience of skill games.

With reference now to FIGS. 1A and 1B, an illustrative computational device 100 that can be used to implement a skill game or the like will be described in accordance with at least some embodiments of the present disclosure. A computational device 100 can include a portable (for example, the device illustrated in FIG. 1B) or non-portable device (for example, the device illustrated in FIG. 1A) used for executing a gaming application or multiple different gaming applications without departing from the scope of the present disclosure. While one device is described as non-portable, it will be understood that such a device should not be considered fixed, but rather not easily movable. Non-limiting examples of a computational device include an electronic gaming machine (EGM), a Video Gaming Machine (VGM), a mobile communication device (e.g., a smartphone, laptop, tablet, and/or wearable device), and a personal computer (PC). An EGM or VGM-type of computational device 100 is shown in FIG. 1A in accordance with embodiments of the present disclosure.

The illustrative computational device 100 of FIG. 1A is shown to include a support structure, housing or cabinet 102, which provides support for a plurality of displays, inputs, controls and other features of a conventional gaming machine. In the illustrated embodiment, a player plays the computational device 100 while sitting, however, the computational device 100 is alternatively configured so that a player can operate it while standing or sitting. The illustrated computational device 100 can be positioned on the floor but can be positioned alternatively (i) on a base or stand, (ii) as a pub-style table-top game (e.g., where the participant computational devices are located remotely from the shared wheel as discussed below), (iii) as a stand-alone computational device on the floor of a casino with other stand-alone computational devices, or (iv) in any other suitable manner. The computational device 100 can be constructed with varying cabinet and display configurations.

In one embodiment, the computational device 100 is configured to generate awards and/or other game outcomes based on probability data. In embodiments, the computational device 100 can generate outcomes based upon various parameters, which can be pre-determined or selected for each game, and can be different for different games, or based on other programmed features, such as generating a probability calculation.

In some embodiments, the computational device 100 can employ a predetermined or finite set or pool of awards, progressive awards, prizes, or other game outcomes. As each award or other game outcome is provided to the player, the computational device 100 removes the provided award or other game outcome from the predetermined set or pool. Once removed from the set or pool, the specific provided award or other game outcome cannot be provided to the player again. The computational device 100 provides players with all of the available awards or other game outcomes over the course of the play cycle and guarantees a designated number of actual wins and losses.

The computational device 100 can include one or more displays 112. An illustrative display 112 can include a credit display that displays a player's current number of credits, cash, account balance or the equivalent. Another illustrative display 112 can include a bet display that displays a player's amount wagered.

The computational device 100 is also shown to include at least one payment acceptor. Illustrative payment acceptors can include, without limitation, a coin slot 124, where the player inserts coins or tokens, and a ticket, note, or bill acceptor 128, where the player inserts a bar-coded ticket, note, or cash. In one embodiment, a player-tracking card, credit card, debit card, or data card reader/validator 132 is also provided for accepting any of those or other types of cards as a form of payment toward playing a game on the computational device 100.

In one embodiment, a player can insert cash or a card into a currency acceptor or card reader 132 of computational device 100, which can generate an amount of credits for play of the skill-game. The identification card can be a smart card having a programmed microchip or a magnetic strip coded with a player's identification, credit totals, and other relevant information. In one embodiment, money can be transferred to computational device 100 through an electronic fund transfer and card reader 132 using the player's credit, debit, or smart card. When a player funds the computational device 100, a processor of the computational device 100 can determine the amount of funds entered and the corresponding amount is shown on the credit or other suitable display 112 as described above.

In one embodiment, after credits have been input/received, the player can initiate game play, such as by engaging buttons, levers, gesture inputs, and/or other input devices that enable a player to start any game play or sequence of events. In one embodiment, upon appropriate funding, computational device 100 begins game play automatically. In another embodiment, the player needs to actuate or activate one of the play buttons to initiate play of computational device 100. Other non-limiting types of input devices 108 can include a “bet one” button, a “max bet” button, or any other type of button known to be included in an EGM, VGM, or the like. It is also contemplated, in embodiments, that a cashier station can comprise an input device via which the player can initiate game play or a sequence of events through appropriate funding.

It should further be appreciated that the input devices 108 can correspond to a physical button, a virtual button on a touch-screen of a game, an input element on a Graphical User Interface (GUI), or a combination thereof. In other words, the input devices 108 do not need to correspond to a physical button. In some embodiments, the player places a bet by pushing a “bet one” button (e.g., betting an amount equal to one credit for the next play). The player can increase the player's wager by one credit each time the player pushes “bet one” button. When the player pushes the “bet one” button, the number of credits shown in the credit display decreases by one, and the number of credits shown in the bet display increases by one. A “max bet” button can also be provided, which enables the player to bet the maximum wager (e.g., max lines, max wager per line, and re-spin operation). The computational device 100 can include other suitable wager buttons, such as a “repeat bet” button (e.g., repeating the bet made from the immediately last play of the computational device 100 for the next play of the computational device 100), one or more “select paylines” buttons, a “select re-spin operation” button, and one or more “select wager per payline” buttons.

Another type of input device 108 that can be provided on the computational device 100 is a physical cash out button, a virtual cash out button, a selectable GUI element, or the like. The player presses a cash out button and cashes-out to receive a cash payment or other suitable form of payment corresponding to the number of remaining credits. The player can receive coins or tokens in a coin payout tray or a ticket or credit slip, which are redeemable by a cashier or funded to the player's electronically-recordable identification card.

The computational device 100 can also include one or more display screens 104 and one or more sound generating devices 136. The combination of outputs provided on a display screen 104 and sound generating device 136 can contribute to the game play experience and, in some embodiments, can provide the player with information regarding a status of a game play event or sequence of events.

In one embodiment, the sound generating device 136 can include at least one speaker or other type of transducer for generating audible sounds and/or playing music. In one embodiment, a computational device 100 provides dynamic sounds coupled with attractive multimedia images displayed on the display screen 104 to provide an audio-visual representation or to otherwise display full-motion video with sound to attract players to the computational device 100. During idle periods, the computational device 100 displays a sequence of audio and/or visual attraction messages to attract potential players to the computational device 100.

FIGS. 1A-1B and 3-5A illustrate embodiments of a skill game shown as a grid-based game with an array of one or more paylines 120 is shown. For purposes of illustration, the game is shown using a series of numbered balls (e.g., billiard balls) arranged in a grid or field having 3 rows and 5 columns. It will be understood that other arrangements and/or symbols also can be used.

As will be discussed in further detail herein, the skill game provided by the computational device 100 can support one or multiple paylines 120, which can extend across the display screen 104 vertically, horizontally, diagonally, and/or at adjusted angles. In some embodiments, such as for a slot game, a payline 120 intersects a plurality of reels 116, such as three to five reels. Each reel 116 of the display screen 104 can be used to display different sets of symbols in connection with game play activity provided by the computational device 100. In some embodiments, each reel 116 can operate independent of all other reels and the symbols displayed by a reel 116. The positions of symbols on each reel 116 and in the combination of reels 116 can form the array of cells in the presentation order rendered to the display screen 104 of the computational device 100.

The reels 116 can be provided in video form with simulated reels being displayed via the display screen 104. A reel 116 can be used to display any number of symbols such as bells, hearts, fruits, numbers, letters, bars or other images and symbols, which preferably correspond to a theme associated with a game provided by the computational device 100. With a slot game, the computational device 100 can be configured to award prizes, awards, or other game play opportunities when the reels 116 stop spinning and a predetermined symbol combination lands across an active payline 120 (for example, a payline 120 that is currently being wagered and is subject to evaluation for a win after the reels 116 have stopped spinning).

FIG. 1B illustrates another example of a computational device 101 in accordance with at least some embodiments of the present disclosure. This particular example of computational device 101 can correspond to a computational device 101 such as a mobile smartphone, tablet, and/or wearable. The computational device 101 can be owned by a user of the computational device 101 rather than being owned by a casino operator.

The computational device 101 and, in another example, the computational device 100) again includes a display screen 105, a plurality of input devices 108, and at least one sound generating device 136 (such as a speaker). In some embodiments, the display screen 105 can correspond to a touch-sensitive display screen, meaning that the display screen 105 is simultaneously capable of displaying information (for example, in connection with game play activity) and receiving a user input (for example, the display screen can act as an input device). In some embodiments, the touch-sensitive display screen 105 can provide game features similar to a cabinet-style computational device 101 without requiring all of the dedicated buttons provided by a cabinet-style computational device 101.

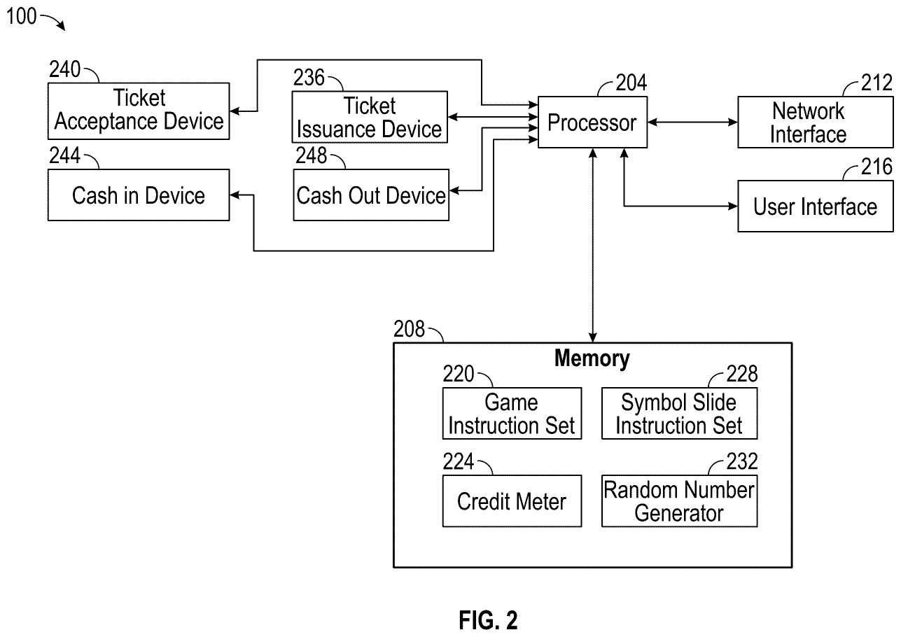

With reference now to FIG. 2, additional details of the components that can be included in a computational device 100 will be described in accordance with at least some embodiments of the present disclosure. The computational device 100 is shown to include a processor 204, memory 208, a network interface 212, and a user interface 216. In some embodiments, the processor 204 can correspond to one or many microprocessors, Central Processing Units (CPUs), microcontrollers, Integrated Circuit (IC) chips, or the like. The processor 204 can be configured to execute one or more instruction sets stored in memory 208. In some embodiments, the instruction sets stored in memory 208, when executed by the processor 204, can enable the computational device 100 to provide game play functionality.

The nature of the network interface 212 can depend upon whether the network interface 212 is provided in cabinet-style computational device 100 or a mobile computational device 100. Examples of a suitable network interface 212 include, without limitation, an Ethernet port, a Universal Serial Bus (USB) port, an RS-232 port, an RS-485 port, a network interface controller (NIC), an antenna, a driver circuit, and/or a modulator/demodulator. The network interface 212 can include one or multiple different network interfaces depending upon whether the computational device 100 is connecting to a single communication network or multiple different types of communication networks. For instance, the computational device 100 can be provided with both a wired network interface 212 and a wireless network interface 212 without departing from the scope of the present disclosure.

The user interface 216 can include a combination of the user input and user outputs described in connection with FIGS. 1A and 1B. For instance, the user interface 216 can include the display screen 104, the input devices 108, the speakers 136, or any other component that is capable of enabling user interaction with the computational device 100. The user interface 216 can also include one or more drivers for the various hardware components that enable user interaction with the computational device 100.

The memory 208 can include one or multiple computer memory devices that are volatile or non-volatile. The memory 208 can be configured to store instruction sets that enable player interaction with the computational device 100 and that enable game play at the computational device 100. Examples of instruction sets that can be stored in the memory 208 include a game instruction set 220, a credit meter 224, and a symbol slide instruction set 228. In addition to the instruction sets, the memory 208 can also be configured to store instructions or information such as a payout table or calculator, for example, to provide game outputs.

In some embodiments, the game instruction set 220, when executed by the processor 204, can enable the computational device 100 to facilitate one or more games of chance or skill and produce interactions between the player and the game of chance or skill. In some embodiments, the game instruction set 220 can include subroutines that present one or more graphics to the player via the user interface 216, subroutines that calculate whether a particular wager has resulted in a win or loss during the game of chance or skill, subroutines for determining payouts for the player in the event of a win, subroutines for exchanging communications with another device, such as a server, subroutines for determining slidable symbol appearances during game play, and any other subroutine useful in connection with facilitating game play at the computational device 100.

In some embodiments, the game instruction set 220 can include instructions that initiate generation of a new game/game filed, which, in some embodiments, could include a reel spin of various reels 116, or, using the example of billiard balls as shown in the Figures, racking of the balls and then “breaking” them apart as would be found in a game of billiards, in connection with game play. Other ways of starting/presenting a next game also game be provided. Typically, in embodiments, the game will be presented without a winning combination already having been created-thus requiring the player to use their skill to win the game. The game instruction set 220 can also be configured to present symbols via the display screen 104 when the reels 116 correspond to video reels or the like. The game instruction set 220 can also be configured to evaluate a position of symbols relative to one or more paylines 120, relative to predetermined symbol areas, or cells in an array of cells, and any other evaluation desired to facilitate game play.

The credit meter 224 can correspond to an instruction set within the computational device 100 that facilitates a tracking of wager activity at the computational device 100. In some embodiments, the credit meter 224 can be used to store or log information related to various player activities and events that occur at the computational device 100. The types of information that can be maintained in the credit meter 224 include, without limitation, player information, available credit information, wager amount information, and other types of information that may or may not need to be recorded for purposes of accounting for wagers placed at the computational device 100 and payouts made for a player during a game of chance or skill played at the computational device 100.

In some embodiments, the credit meter 224 can be configured to track coin in activity, coin out activity, coin drop activity, jackpot paid activity, credits applied activity, external bonus payout activity, voucher in activity, voucher out activity, timing of events that occur at the computational device 100, and the like. In some embodiments, certain portions of the credit meter 224 can be updated in response to outcomes of a game of chance or skill played at the computational device 100.

The symbol slide instruction set 228 can correspond to a subroutine that is called by the game instruction set 220 during game play. In some embodiments, the symbol slide instruction set 228 can be called by the game instruction set 220 when the game instruction set determines that a sliding symbol operation is available and/or that a particular symbol in the array of cells is assigned as a slidable symbol. In some embodiments, the symbol slide instruction set 228 is configured, when executed by the processor 204, to prompt a player for a movement of an identified slidable symbol (for example, identifying the slidable symbol with an identifying mark) that the player can wish to move to a different cell location during a game play.

In embodiments, the symbol slide instruction set 228 can further receive the user input (for example, by the player selecting the identified slidable symbol in a first cell and providing a “dragging” movement to another cell in the array of cells) that moves the slidable symbol to the desired cell location in the array of cells. The symbol slide instruction set 228 can be configured to identify which symbol in the array of cells is eligible to be moved (for example, slid) or, conversely, which symbol in the array of cells is ineligible from being moved and then maintained during the subsequent play. In other embodiments, the symbol slide instruction set 228 can be configured such that all symbols are moveable.

It is the cooperation of the game instruction set 220 and symbol slide instruction set 228 that helps increase the desirability of the overall gaming experience and that gives a player the sense of control over the game that can increase their desire to continue playing the computational device 100. As noted, any symbol in the playfield can be slidable. In a further embodiment, once a selected time has lapsed and/or if a player selects a next game, then the symbols can be refreshed.

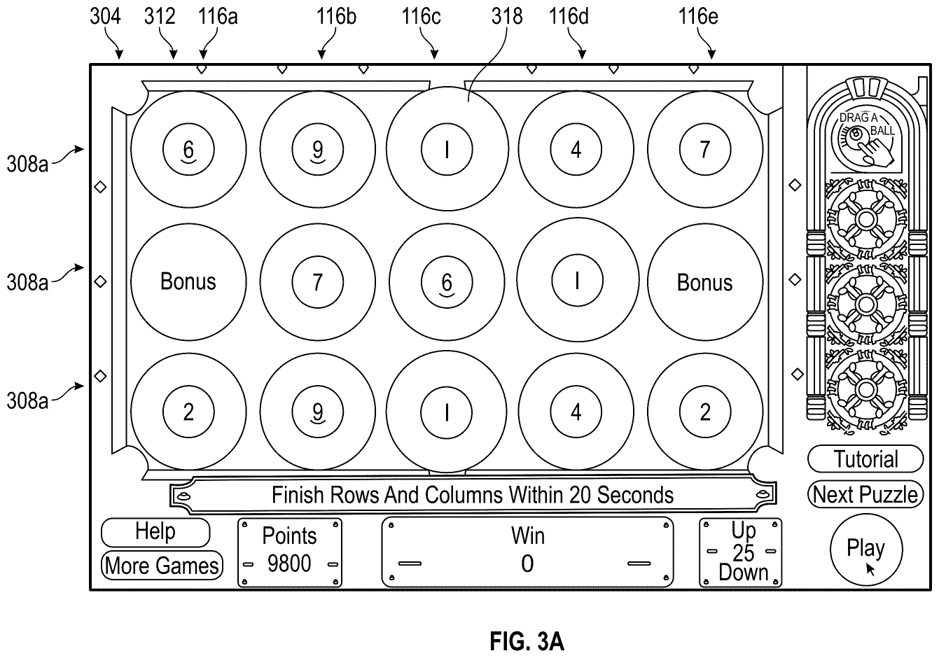

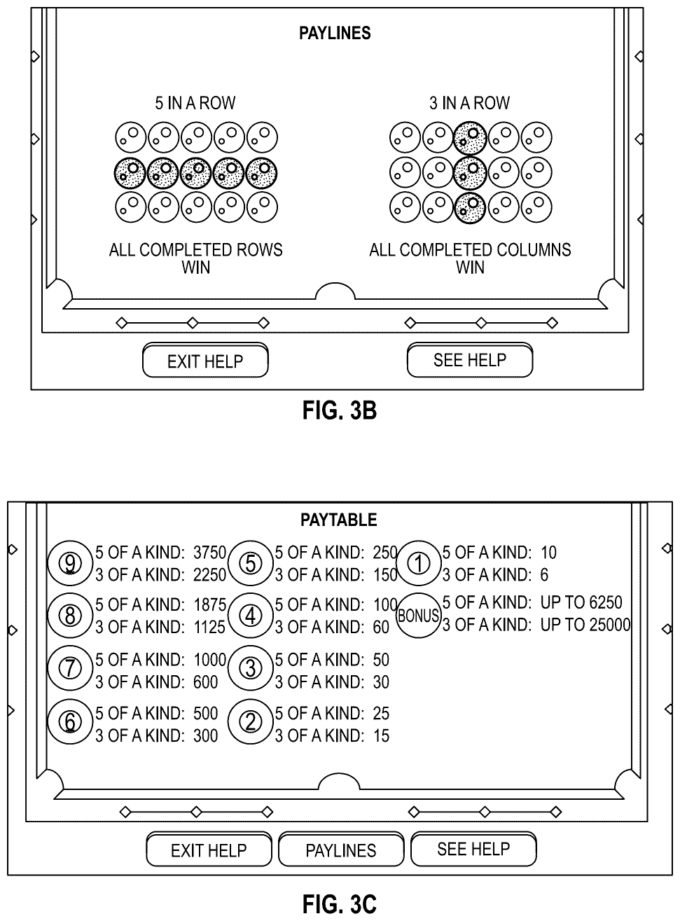

While shown as separate instruction sets, it should be appreciated that the symbol slide instruction set 228 can correspond to a subroutine of the game instruction set 220 without departing from the scope of the present disclosure. Additional details and functional capabilities of the symbol slide instruction set 228 working in cooperation with the game instruction set 220 will be described in connection with FIGS. 3A-5.

The computational device 100 is further shown to include a ticket issuance device 236, a ticket acceptance device 240, a cash in device 244, and a cash out device 238. The ticket issuance device 236 can be configured to receive physical tickets, vouchers, or player loyalty cards. In some embodiments, the ticket issuance device 236 and ticket acceptance device 240 can operate in concert with the ticket acceptor 128. In such an embodiment, the ticket acceptor 128 can correspond to the physical components that receive and issue a ticket or voucher whereas the ticket issuance device 236 and the ticket acceptance device 240 correspond to the drivers and/or firmware components that control operation of the ticket acceptor 128.

It should also be appreciated that the card reader 132 can be in communication with the ticket issuance device 236 and the ticket acceptance device 140 and can have functionality driven by one or both of these devices. For instance, the card reader 132 can correspond to the physical hardware components that receive information from a player loyalty card (or player loyalty application running on a mobile communication device) and that information can be processed by the ticket acceptance device 240 when receiving player credits from cards read by the card reader 132. The ticket issuance device 236 can provide the card reader 132 with information for applying wager credits back to a player card when a player is done with a game play session and wishes to transfer credits from the credit meter 224 back onto their card. Thus, the ticket issuance device 236 and ticket acceptance device 240 can also operate as a driver and/or firmware component for the card reader 132.

Similarly, the cash in device 244 and cash out device 248 can include or operate in concert with the coin slot 124 and any coin delivery mechanisms. The cash in device 244 and cash out device 248 can include hardware, drivers, or firmware that facilitate receiving or distributing cash, tokens, and/or bills. In some embodiments, the cash in device 244 can be configured to determine an amount of cash (for example, in coins and/or bills) and/or an amount or number of tokens input at the coin slot 124 and convert the values into credits for playing games with the game instruction set 220. The cash out device 248 can correspond to hardware and software configured to output coins, tokens, and/or bills if a player decides to cash out or convert playing credits back into coins, tokens and/or bills.

With reference now to FIGS. 3A-5, an example of a sliding symbol or click and drag type skill game is shown for purposes of illustration and not limitation. Various operations of the game instruction set 220 and the symbol slide instruction set 228 will be described in accordance with at least some embodiments of the present disclosure. For example, in embodiments, the game can include game instructions that define a series of pay-lines, one on each column and one on each row. As such, aligning a plurality of matching symbols on a column can generate a winning outcome. Likewise, aligning five matching pool-ball symbols on a row can generate a winning outcome.

Referring further to FIGS. 3A and 4A-5, which illustrate in further detail embodiments of a skill game such a 3×5 game as discussed above, a first layout of symbols 318 rendered to an array of cells 304 of a skill game will be described in accordance with embodiments of the present disclosure. The array of cells 304 can be presented, or otherwise rendered, with the display screen 104. In some embodiments, the game instruction set 220 can control which particular symbols 318 are presented within a particular cell 312 in the array of cells 304.

In an example embodiment, the illustrative array of cells 304 is shown to include five columns 116a, 116b, 116c, 116d, 116e of cells 312 and three rows 308a, 308b, 308c, of cells 312. Although FIG. 3A illustrates a 3×5 array of cells 304, it should be appreciated that embodiments of the present disclosure can be implemented in an array of cells 304 having a variety of sizes. For instance and without limitation, embodiments of the present disclosure can be used in an array of cells 304 that are 3×3, 4×4, 4×5, 5×3, 5×5, 7×3, 10×5, 10×10, and/or arrays of various other sizes. The example layout of the array of cells 304 should not be construed as limiting embodiments of the present disclosure.

As can be seen in FIG. 3A, each cell 312 in the array of cells 304 can be populated with a single symbol 318 (such as, in a non-limiting example, billiard balls, as illustrated). In other words, after the processor executes the game instruction set 220 to determine symbol 318 placement throughout the array of cells 304, there will be a 1:1 correlation of symbols 318 to cells 312. Each column 116a, 116b, 116c, 116d, 116e can also be referred to as a reel 116, particularly in the event that the game instruction set 220 provides a slot game. In some embodiments, a symbol 318 can correspond to an absence of a symbol or a blank symbol. For example, this blank symbol can correspond to a symbol in a cell 312 having no value.

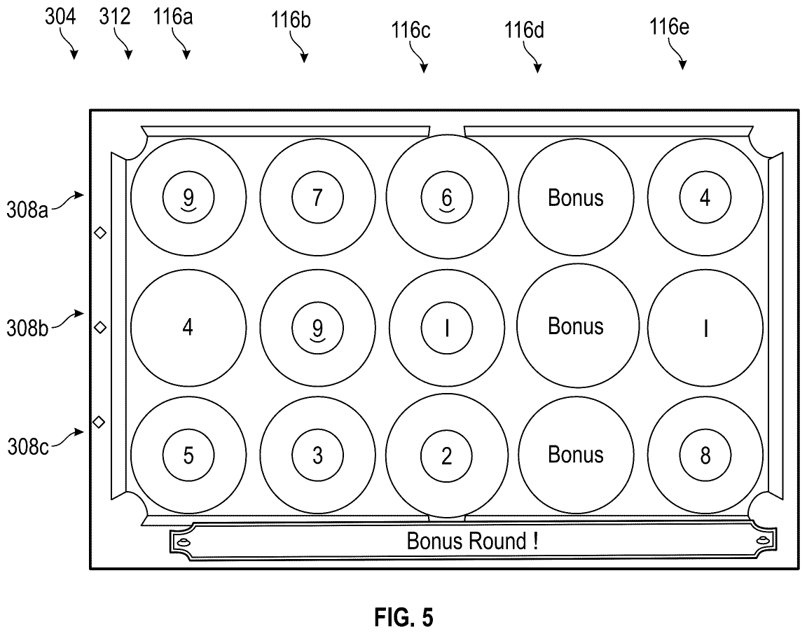

In some embodiments, rewards, prizes, payouts, or other predetermined game outcomes (e.g., bonus spin opportunities, prize wins, cash wins, re-spin bonus plays, e.g., FIG. 5) can be determined based on a symbol combination that falls on a payline 120 that was subject to a wager prior to the spin. In some embodiments, a plurality of the paylines 120 can be selected for “play” prior to a spin, meaning that any payline 120 selected for “play” will be evaluated for a predetermined symbol combination, or sequence of symbols 318. Examples of a sequence of symbols 318 can include, but are in no way limited to, at least one of the sequence [A; 1; F; 6; K] associated with the first row 308a, the sequence [B; 2; G; 7; L] associated with the second row 308b, and/or the sequence [C; 3; H; 8; M] associated with the third row 308c. In another embodiment, a successful or winning sequence can include positioning matching symbols in a column, row, or diagonally. For example, lining up each 1 ball in FIG. 3A can result in a win.

Additionally or alternatively, the sequence of symbols 318 can include, but are in no way limited to, a sequence of symbols 318 in an order along one or more of the vertical lines of cells 312 associated with the columns 116a-116e (e.g., the sequence [A; B; C; D; E], the sequence [1; 2; 3; 4; 5], and/or reverse sequences of the same). In some embodiments, the sequence of symbols 318 can include, but are in no way limited to, a sequence of symbols 318 in an order along one or more of the cells 312 having a payline 120 running therethrough (e.g., the first diagonal payline sequence [A; 2; H; 9; 0], the second diagonal payline sequence [E; 4; H; 7; K], the first vertical payline sequence [A; B; C; D; E], the first horizontal payline sequence [C; 3; H; 8; M], and/or reverse sequences of the same). In one embodiment, the sequence of symbols can comprise all sequences of symbols associated with each row 308a-308c and/or column 116a-116e.

A selected payline 120 can also correspond to a payline 120 that is evaluated after symbols 318 have been subjected to a sliding symbol operation by the symbol slide instruction set 228. In some embodiments, however, it can be possible to switch or select more paylines 120 for evaluation after a spin has completed, but before a subsequent play operation (e.g., re-spin) has been performed. The addition of more paylines 120 after the original spin but prior to the subsequent play operation can require the user to provide more credits to the game instruction set 220 as part of enabling evaluation over more paylines 120. An example of an embodiment of a payline layout based on a 3×5 grid of symbols is shown in FIG. 3B. In another embodiment, the amusement system can enable or allow a player to reset all the symbols rendered, without ending a play or game. In such embodiments, the user can select reset while the time or timer continues to count down. In such embodiments, the reset may not alter the time or timer. In addition, an example embodiment of a pay table for such a game is shown in FIG. 3C.

Although shown having four different linear paylines 120 (e.g., horizontal, vertical, and/or diagonal), one or more paylines 120 can be associated with cells 312 in any shape the array of cells 304. In one embodiment, a payline 120 can run through a single row 308a-308e of the array of cells 304 (e.g., first row 308a). In some embodiments, a payline 120 can run through one or more columns 116a-116e in the array of cells 304. In any event, embodiments of the present disclosure are not limited to the position and/or shape of the paylines 120 shown in FIGS. 3A-5.

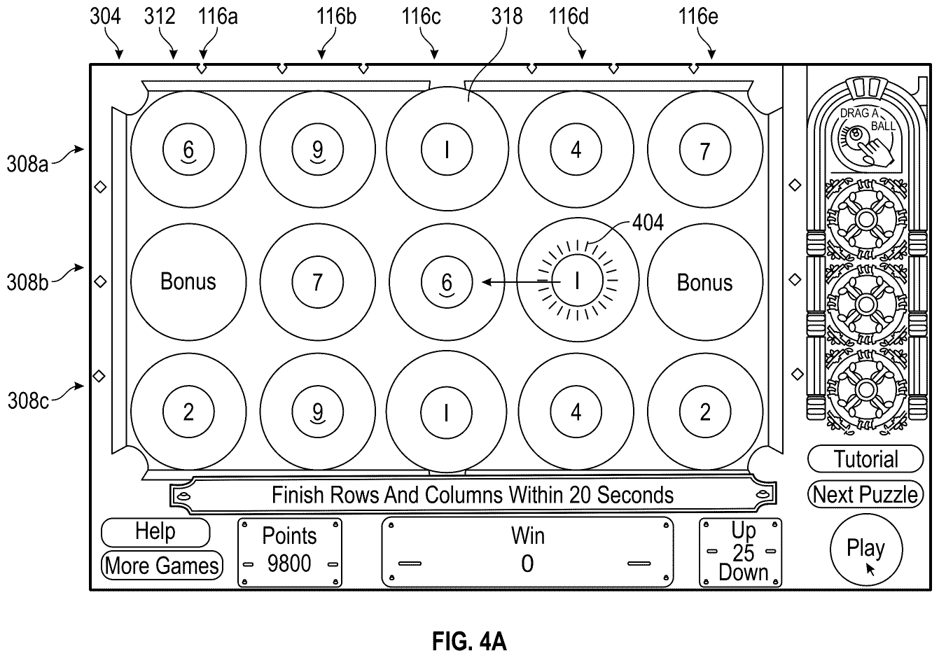

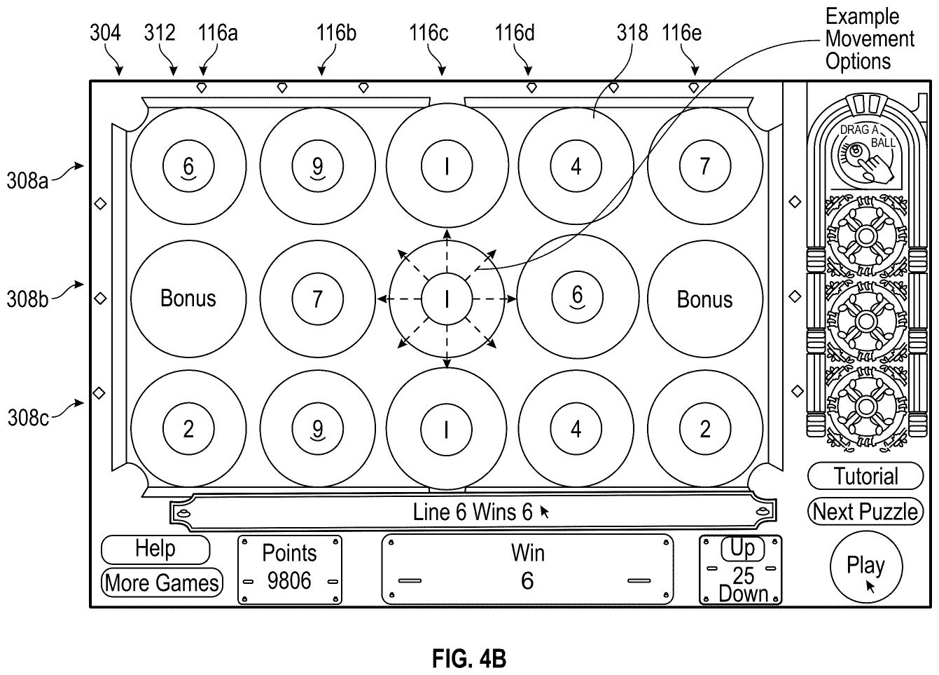

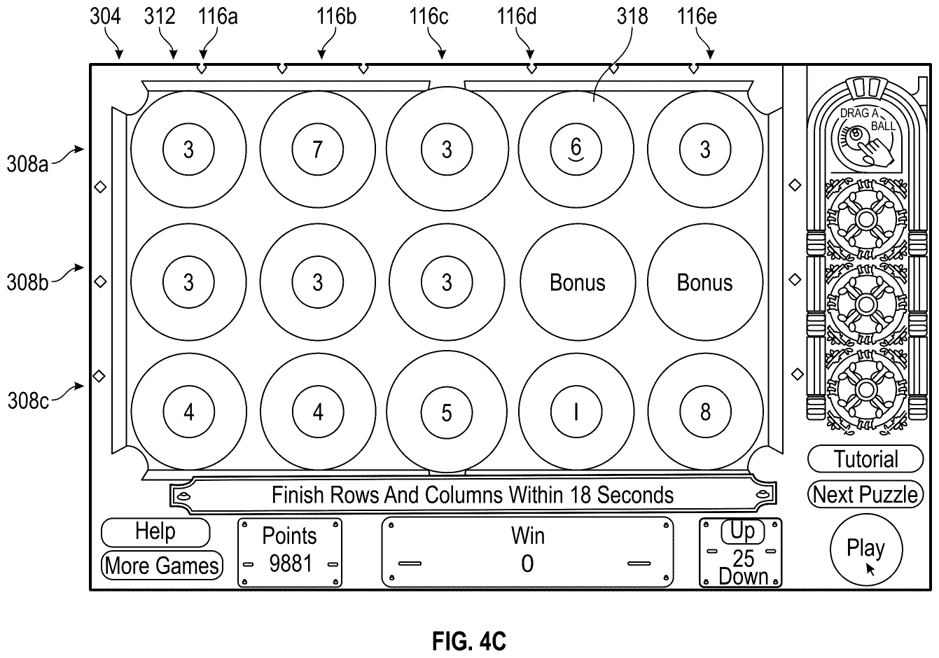

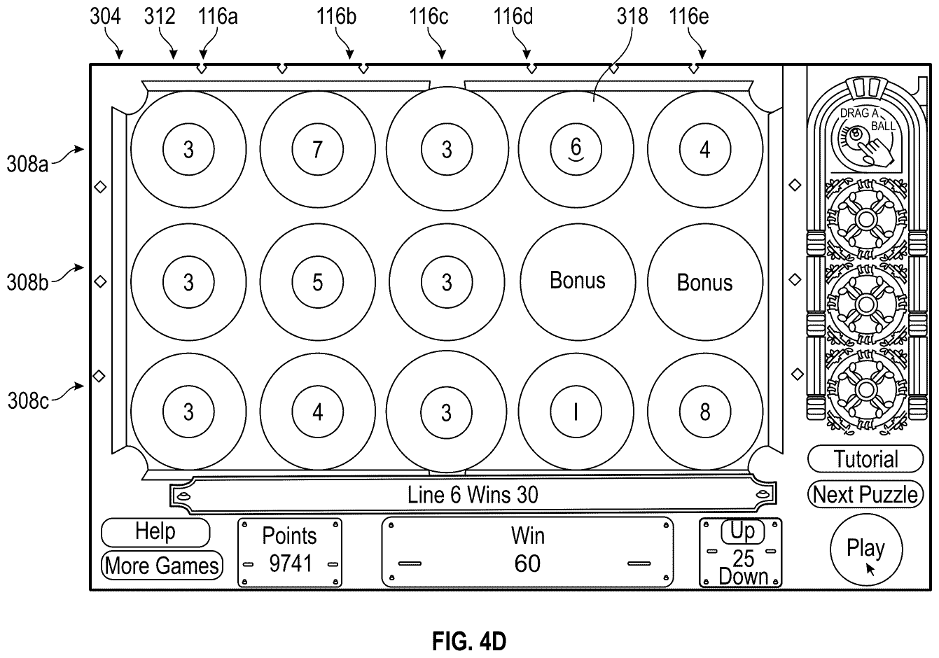

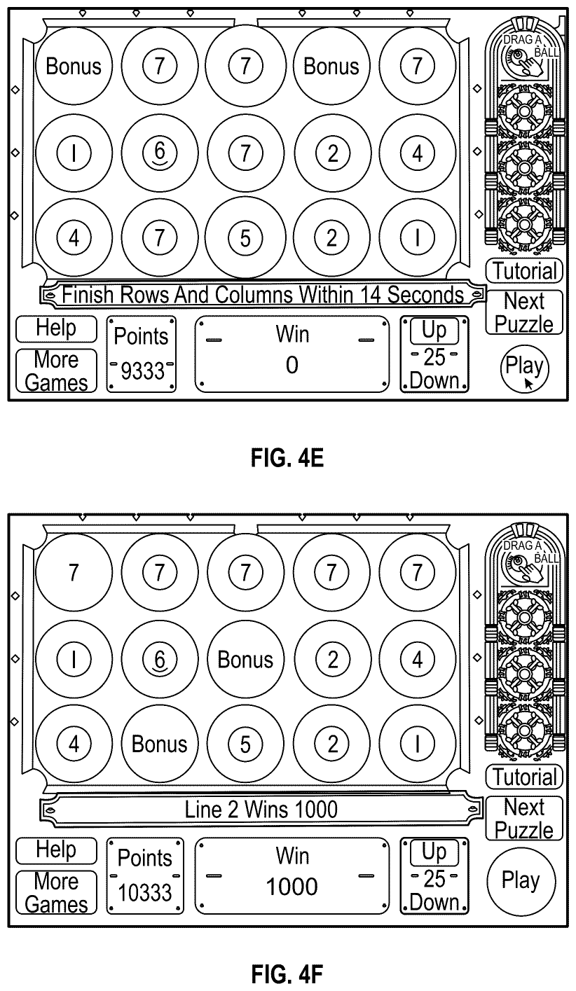

Referring now to FIGS. 4A-4D, an illustrative game play sequence that can be performed by the game instruction set 220 and the symbol slide instruction set 228 will be described in accordance with at least some embodiments of the present disclosure. In some embodiments, FIGS. 4A-4D illustrate various presentations that are caused to be rendered by a display screen 104 of the computational device 100.

A game begins by pressing PLAY, which can be a hardware or on-screen software button. After pressing PLAY (which can include selecting a number of credits for the game—the more credits, the greater a potential prize to be awarded), the symbols animate to form a non-winning pattern. As such, no consecutive matching symbols exist to automatically create a winner on any pay-line.

In the example of FIG. 4A, a slidable symbol is shown to have landed in a symbol area 312. Specifically, the slidable symbol is shown to have landed in the symbol area 312 that resides at the intersection of the second row 308b and the fourth column 116d. The original play, or spin, and placement of symbols 318 throughout the array of cells 304 can have been determined by the game instruction set 220. Stated another way, each cell 312 in the array of cells 304 is populated with a respective discrete symbol 318 that is rendered by the display screen 104 of the computational device 100. The symbols 318 further generally can appear to be randomly assigned to each cell 312 in the array of cells 304.

In embodiments, the position of symbols 318 in the array of cells 304 can be evaluated by the game instruction set 220 to determine if a predetermined game outcome has occurred (e.g., a wager has resulted in a win or prize, a slidable symbol is available). For instance, the game instruction set 220 can determine if a sequence of symbols 318 along a payline 120 corresponds to a winning game outcome. The sequence of symbols 318 can correspond to an order of symbols 318 in a particular sequence as defined by the rules of the game. In one embodiment, a winning outcome for a sequence of symbols 318 can require at least one of a first symbol to appear in the first column 116a of a payline 120, a second symbol to appear in the second column 116b of the same payline 120, a third symbol to appear in the third column 116c of the same payline 120, a fourth symbol to appear in the fourth column 116d of the same payline 120, and a fifth symbol to appear in the fifth column 116e of the same payline. Depending on the rules of the game, these symbols 318 can be required to be the same, for example, forming a match between two or more cells 312 in the sequence of symbols 318.

In FIG. 4A, the game instruction set 220 and/or the symbol slide instruction set 228 generates a slidable symbol associated with a particular symbol 318 in the cell 312 at the intersection of the second row 308b and the fourth column 116d. In some embodiments, the slidable symbol can be made available in response to a previous game play, a wager amount, and/or a historical game play. The placement and position, or cell 312, associated with the slidable symbol in the array of cells 304 can be determined (e.g., via the game instruction set 220 and/or the symbol slide instruction set 228 executing instructions). As provided above, the type of the slidable symbol can correspond to any type of particular symbol 318 used in the game. In one embodiment, the slidable symbol can correspond to a bonus symbol type, a high-probability winning symbol type (e.g., cherries, diamonds, and/or multipliers), and/or some other symbol that can increase the player's chances of winning on a subsequent play where the slidable symbol is maintained in a particular cell 312 in the array of cells 304.

In an embodiment, the slidable symbol can be rendered to the display screen 104 along with an identifying mark. The identifying mark can include crosshairs, or a “plus” symbol. The identifying mark can indicate to a player that the slidable symbol can be moved, or slid, to another cell 312 in the array of cells 304. In one embodiment, a player can interact with the identifying mark (e.g., by selecting the slidable symbol for movement by touching, or clicking, on the identifying mark 404) to move the slidable symbol to another cell 312. The identifying mark 404 can be represented as a highlight, an underscore, an animated region of the cell 312 housing the slidable symbol, an animated icon, any other icon, and/or combinations thereof. In another embodiment, a player can add identifying marks for additional credits. In yet another embodiment, no identifying marks can be provided

In response to the player interacting with the slidable symbol and/or the identifying mark associated with the slidable symbol (e.g., by touching and/or clicking at an input device 108 or other user interface), a subsequent output or presentation, as shown in FIG. 4B, can be displayed by the display screen 104 showing movement (e.g., sliding) of the slidable symbol. In another embodiment, movement options can be available or displayed. These movement options can extend outwardly and away from the slidable symbol in the array of cells 304. Depending on the rules of the game, the movement direction can define available movement options and/or movement restrictions for the slidable symbol. For instance, in one set of rules, the slidable symbol can only be moved from the cell 312 in which it first appeared along a column 116a-116e or along a row 308a-308c to another cell 312 in the same column 116a-116e or in the same row 308a-308e, respectively. In some embodiments, the slidable symbol can only be moved from the cell 312 in which it first appeared along a payline 120 to another cell 312 running through the same payline 120. In other embodiments, the slidable symbol (or any of the symbols) can be moved to any other cell 312.

As illustrated in FIG. 4B, the slidable symbol can be moved horizontally along the payline 120 associated with the third row 308c along a direction to the left-hand side or the right-hand side of the cell 312 in which the slidable symbol first appeared. By way of example, the slidable symbol can be moved (e.g., slid, dragged) from the cell 312 at the intersection of the second row 308b and the fourth column 116d to the cell 312 at the intersection of the second row 308b and the third column 116c.

In some embodiments, the slidable symbol can be moved vertically along the fourth column 116d along a direction to the top side or the bottom side of the cell 312 in which the slidable symbol first appeared. For example, the slidable symbol can be moved from the cell 312 at the intersection of the second row 308b and the fourth column 116d to one of the cell 312 at the intersection of the first row 308a and the fourth column 116d, and the cell 312 at the intersection of the third row 308c and the fourth column 116d.

In one embodiment, the slidable symbol can be moved diagonally from the cell 312 in which the slidable symbol first appeared to a cell 312 that runs along the payline 120 running from the cell 312 at the intersection of the first row 308a and the first column 116a to the cell 312 at the intersection of the third row 308c and the fifth column 116e. Additionally or alternatively, the slidable symbol can be moved diagonally from the cell 312 in which the slidable symbol first appeared to a cell 312 that runs along the payline 120 running from the cell 312 at the intersection of the third row 308c and the first column 116a to the cell 312 at the intersection of the first row 308a and the fifth column 116e.

In some embodiments, the array of cells 304 can only include a single row 308c of cells 312 making up the array of cells 304. Alternatively, the array of cells 304 can only include a single column 116c of cells 312 making up the array of cells 304. In this alternative example, the movement direction arrows 408 can indicate that movement of the slidable symbol is only available along a vertical direction to a cell 312 that runs along a line in the vertical direction.

In a subsequent output, or presentation, shown in FIG. 4C, it is contemplated that multiple slidable symbols can be re-arranged, slide, or dragged to generate at least one column with three matching symbols in a column and/or to generate at least one row with five matching symbols. Continuing the sliding movement input provided by the player in FIG. 4C, FIG. 4D shows a position of the slidable symbol when the slidable symbol(s) has been dragged to the appropriate cells or positions. When a slidable symbol has been dragged from one cell 312 to another, the type of the symbol 318 associated with the slidable symbol remains the same as when it first appeared for at least one subsequent paid-for play. By way of example, if the type of the symbol 318 that first appeared in the cell 312 at the intersection of the third column 116c and the third row 308c was a “cherry,” then the type of the symbol 318 that is dragged to the intersection of the first column 116a and the third row 308c would be maintained as a “cherry.”

Among other things, this slidable-manipulability can enable a player to setup a line, or sequence, of symbols 318 with a particular symbol dragged to a player-selected cell 312 and/or position in the presentation order of the array of cells 304 and alter at least one of a proposed payout amount and the players chances of winning in a subsequent, or next, play. For the next play, in this example, the slidable symbol dragged to the intersection of the first column 116a and the third row 308c would be maintained as a “cherry,” while the other symbols 318 in the array of cells 304 can be recalculated (e.g., via the game instruction set 220 and/or the symbol slide instruction set 228) and rendered to the other cells 312 in array of cells 304 (e.g., other than the cell 312 at the intersection of the first column 116a and the third row 308c).

During play of the game, the player can make multiple moves to solve/win the game. Further, a player can make moves to partially solve/win the game. For example, as shown in FIGS. 4C and 4D, a player has successfully solved/won the game. However, a player can also partially solve/win the game as presented in FIG. 4C. The player can, for example, align the symbols in one column, rather than both. In such an example, the player can receive a partial award or smaller award than if the player completely solved/won the game. Such a scenario can occur if the player completes one column and the timer elapses prior to completion of the second column. In yet another embodiment, the player can finish a row, rather than two columns. In such an embodiment, the player can receive a higher value prize or a greater RTP than if the player completed one column, but less than if they completed two columns.

In a subsequent output, or presentation, shown in FIG. 4D, several symbols can be re-arranged, slide, or dragged to generate two columns with three matching symbols in a column or to generate a row with five matching symbols.

In some embodiments, the position of the cell 312 to which the slidable symbol was dragged in the presentation order of the array of cells 304 can determine whether a behavior of the game should be altered. Game behavior can include proposed payout amounts, odds or chances of winning, subsequent number of plays where the slidable symbol is maintained in a particular position and/or additional wagers required. For example, in reel-spin, or slot, games, each reel 116 in the array of cells 304 can be associated with a particular priority. The first column 116a in a reel-spin game typically has a first priority, the second column 116b has a second priority, and the third column 116c has a third priority.

In embodiments, these priorities can be ordered, from a first priority to the fifth priority, in order from the highest priority to the lowest priority. When a particular symbol 318 lands in a cell 312 having the first priority, the chances of obtaining a winning sequence of symbols 318 as the game outcome increases (e.g., the probability of winning becomes better). Additionally or alternatively, when a particular symbol 318 lands in a cell 312 having the fifth priority, the chances of obtaining a winning sequence of symbols 318 as the game outcome decreases (e.g., the probability of winning becomes worse).

In some embodiments, however, a player can be incentivized to move from a cell 312 having a higher priority to a cell 312 having a lower priority to at least one of increase a potential payout amount, maintain the slidable symbol in the cell having the lower priority for a greater number of plays (e.g., spins), and have the opportunity to gain an additional slidable symbol in the next play. In addition, in embodiments, by continuing the sliding movement input first provided by the player, FIG. 4D shows a position of the slidable symbol when the slidable symbol has been dragged to cells corresponding to two completed columns.

In addition, in embodiments, a timer can be activated and begin a countdown. The player then manipulates symbols by dragging selections to a desired location before time expires. Embodiments of the method for manipulating the symbols could vary by game. After achieving the best possible symbol alignment, the game completes, at which point, the game controller or processor can evaluate the onscreen symbols to determine any winning amount. The game will reward the player if the selected winning symbols or a pattern thereof are placed on one or more pay lines or if the symbols or patterns thereof are fully completed, as several patterns to partially solve/win the game can exist. The game will time out if the best combination is not achieved before time expires. In embodiments, the timer can be adjusted based on a reward selected by the player. For example if a player selects a prize with a higher value, or decides to wager a higher amount of credits for a higher RTP (e.g., to gain a return of a greater number of credits), then the timer can decrease.

By way of example, with reference to FIGS. 4A and 4E and 4F, consider a line-up or sequential arrangement wherein arrangement of five 3-balls pays 50 credits or three 3-balls pay 30 credits, or a multiple thereof. As indicated in FIG. 4A, if the player selects a minimum number of credits for a play of the game, or a level of game play that is at or below a selected threshold, the timer can be set to a first predetermined amount, e.g., 20 seconds to solve the game. If the player is successful at solving/winning the game, they can only win a first amount (e.g., 6 credits as indicated in FIG. 4B). As indicated in FIGS. 4E-4F, where the player selects to play for a higher reward or higher wager of credits, the timer can be correspondingly adjusted (e.g., dropped to 14 seconds as shown in FIG. 4E, though other times can be set). If the player exercises skill and solves the game within the shortened time, they can win a higher reward (e.g., 1000 credits as indicated in FIG. 4F).

After pressing PLAY, the symbols animate, ending on (at least initially) a non-winning pattern. As the timer begins, the player searches the play-field for matching symbols, observing several 3-balls. An example of the play field prior to the player taking action is shown in FIG. 4E. As an exercise of skill, the player must then discern the best combination of symbols and take an appropriate action within an allotted time. If only three matching symbols exist, one column win is likely possible. If five exist, one row win is likely possible. If six exist, two column wins are likely possible. The player must deduce the best action, then select and place (e.g., drag or move across the game field or grid) the balls in the highest rewarding positions before time expires.

As further shown in FIGS. 4E-4F, in embodiments, if five 3-balls balls exist in the play-field, the player should place all five on a pay-line to achieve the 50 credit reward. If time expires without the player arranging matching symbols onto a pay-line, no reward is given. If the player arranges only three balls on a column, the game will reward 30 credits even though a 50 credit win was available. In such an example, the player exercised skill but not the level of skill required to receive the maximum payout. If six 3-balls exist, the player should place three 3-balls on two separate columns to achieve the maximum reward available on that play or five 3-balls in a row or three 3-balls in one column to achieve a partial reward.

FIG. 5 illustrate a bonus stage based on a matching of selected symbols. Once the selected symbols are aligned, the display can be transitioned to a bonus stage. Such a stage can, as a non-limiting example, include a score multiplier.

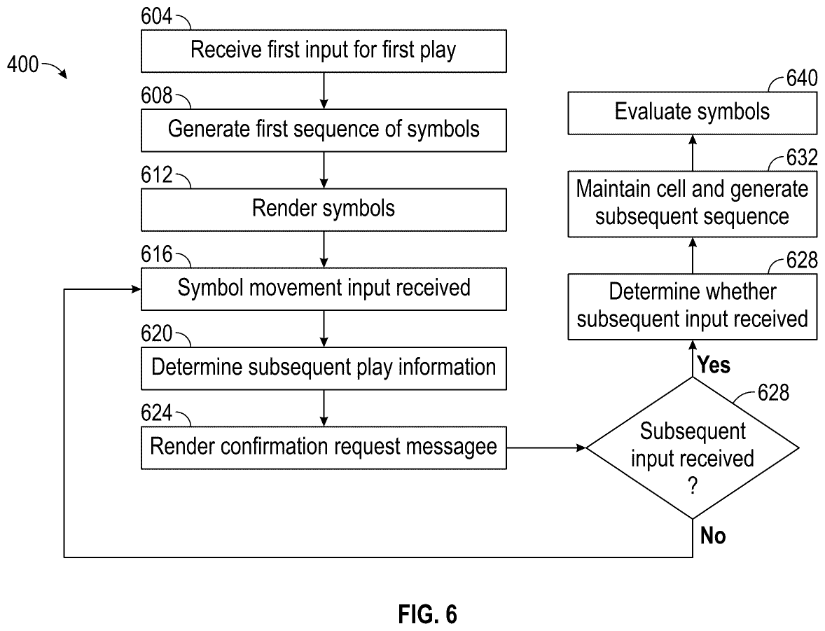

With reference now to FIG. 6, a flow diagram depicting a method of an example process for enabling a sliding symbol operation in a skill game is shown in accordance with embodiments of the present disclosure. The methods described herein can be run as a set of instructions on a computational device 100 and/or some other server in communication with the computational device 100. In some embodiments, the set of instructions can be part of an application installed on the computational device 100.

In embodiments, the method can include initiating game play by receiving a first input initiating a first play of a skill game (step 604). This step can occur in response to the player selecting a predetermined button or providing an input via some other input device 108, inserting coins, cash, tickets, and/or vouchers or performing some other action at the computational device 100 indicates a desire to begin game play. In one embodiment, the first input can correspond to an input provided by the player via an input device 108. For example, the first input can correspond to a button press, a touch of a screen, a lever actuation, a gesture, and/or some other physical input provided by the player. In embodiments, a game will be displayed, and in some embodiments, can comprise a skill game with a game field having a series of rows and columns. In embodiments, the skill game can correspond to a reel-spin game, a matching game, and/or any other game having a sequence of symbols 318 arranged in a presentation order.

In response to receiving the first input, the method continues by generating a first sequence of symbols for the first play (step 608). In some embodiments, the game instruction set 220 initiating the first play (e.g., a first reel spin) can be configured to determine a final position of symbols 318 to be rendered in the array of cells 304. In some embodiments, the game instruction set 220 and/or the symbol slide instruction set 228 can be further configured to determine a particular symbol in the array of cells 304 that is associated with a sliding symbol operation. The skill game can be arranged as an array of cells 304 having a specific presentation order that defines a specific position of each cell 312 in the array of cells 304 relative to one another. The symbols 318, including the particular symbol associated with the sliding symbol operation, are rendered in the array of cells 304 via the display screen 104 of the computational device 100 (step 612). This first sequence of symbols 318 can be rendered to the array of cells 304 such that each cell 312 in the array of cells 304 comprises a discrete symbol 318 in the first sequence of symbols 318.

A discrete symbol can comprise any symbol, including a blank symbol, associated with the skill game that has been generated for a cell 312 in the array of cells 304 from a predetermined group of symbols 318. As described in conjunction with FIGS. 4A-4D, the slidable symbol can be rendered along with an identifying mark 404. This identifying mark 404 can indicate to a player that a particular symbol is a slidable symbol, or associated with a slidable symbol operation, that can be moved to a new position in the array of cells 304 for a subsequent play.

Next, game play generally proceeds when a symbol movement input is received dragging the particular symbol from one cell 312 to another in the array of cells 304 (step 616). This movement can be provided by a player selecting the particular symbol in the cell 312 to which the particular symbol first appeared and then by sliding the particular symbol to a new cell position along an acceptable line in the array of cells 304. The player interacting with the computational device 100 can drag the particular symbol 318 in the rendered first sequence of symbols identified as being a slidable symbol from an associated cell 312 (e.g., the first cell in which the particular symbol is rendered) in the array of cells 304 to a second cell (e.g., a different cell) in the array of cells 304. Examples of this movement input, and acceptable lines of movement are described in conjunction with FIGS. 4A-4F above.

The method can then determine subsequent play information based on the dragged position of the particular symbol being in a different dragged-to cell 312 in the array of cells 304 (step 620). In some embodiments, this subsequent play information can include determining at least one of odds of winning associated with the particular symbol being in the dragged-to cell 312, a number of subsequent plays available to the player for the particular symbol being in the dragged-to cell 312, whether any odds need to be adjusted for a potential payment amount to comport with gaming regulations. The method can proceed by rendering a confirmation request message regarding the dragged-to position of the particular symbol and subsequent play information (step 624). In embodiments, such a confirmation request message can be rendered as a pop-up window 504 and the subsequent play information can be rendered to a subsequent play information area 506 of the pop-up window 504, as described in conjunction with FIG. 5A above.

The method can continue by determining whether a subsequent play input is received from the player (step 628). The subsequent play input can comprise a confirmation provided by the player via selecting the “yes” icon 508 of the pop-up window 504, selecting a predetermined button (for example, input device 108), inserting coins, cash, tickets, and/or vouchers or performing some other action at the computational device 100 that indicates a desire to initiate the second game play with the slidable symbol maintained in the dragged-to cell 312. In some embodiments, the subsequent play input can correspond to a button press, a touch of a screen, a lever actuation, a gesture, and/or some other physical input provided by the player. The subsequent play input initiates a subsequent play of the skill game with the particular symbol maintained in the second cell 312 of the array of cells 304. If the player fails to provide the subsequent play input, the method can return to step 616 allowing the player to reposition the particular symbol, or slidable symbol, to a different dragged-to cell 312 in the array of cells 304.

In response to the player providing the subsequent play input, the method continues by maintaining the particular symbol in the dragged-to cell and generating a subsequent sequence of symbols to the array of cells 304 other than for the dragged-to cell for the subsequent play (step 632). In some embodiments, the game instruction set 220 initiating the subsequent play (e.g., a subsequent reel spin) can be configured to determine a final position of symbols 318 to be rendered in the array of cells 304 excluding the maintained particular symbol in the dragged-to cell. These symbols 318, including the particular symbol associated with the sliding symbol operation that is maintained in the dragged-to cell, are rendered in the array of cells 304 via the display screen 104 of the computational device 100 (step 636).

After the subsequent game play is completed, the game instruction set 220 can evaluate symbols 318 laid out in the array of cells 304 (step 640). The evaluation of symbols 318 can include determining which paylines 120 will be subject to evaluation and whether any of the selected paylines 120 have a predetermined combination of symbols 318 provided thereon. In some embodiments, the evaluation of the symbols can comprise determining, based on a position of the particular symbol maintained (e.g., in the dragged-to cell 312) and a position of each symbol 318 in the subsequent sequence of symbols relative to the previous presentation order, a game outcome of the subsequent play of the skill game. In one embodiment, the game instruction set 220 will evaluate the symbols 318 that land on a particular payline 120 or a plurality of paylines 120 to determine if the subsequent play resulted in a predetermined game outcome. This predetermined game outcome can include winning a prize, winning playing credit, winning money, winning a bonus spin, and/or achieving a game achievement. Depending on the number of plays associated with the particular symbol and slidable symbol feature (e.g., being greater than one), the method can continue by receiving another subsequent play input where at least step 632 through step 640 are repeated for each available subsequent play. In some embodiments, the method can allow the player to move the particular symbol to yet another different cell between plays. In this example, the method can repeat steps 616 through 640.

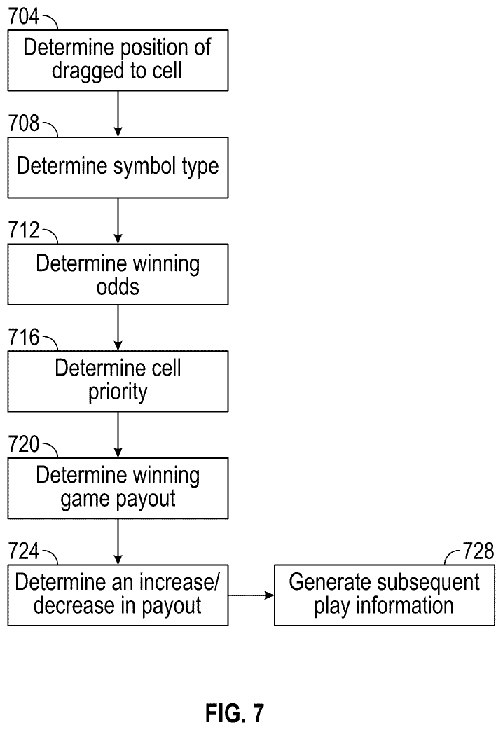

FIG. 7 is a flow diagram of an example process for determining subsequent play information associated with performing a sliding symbol operation in the skill game. The methods described herein can be run as a set of instructions on a computational device 100 and/or some other server in communication with the computational device 100. In some embodiments, the set of instructions can be part of an application installed on the computational device 100. In some embodiments, the method for determining subsequent play information can be performed as part of step 620, or in response to step 616, of the flow diagram described in conjunction with FIG. 6.

In the example embodiment of the method illustrated in FIG. 7, the method can begin by determining a position of the dragged-to cell comprising the particular symbol (e.g., the slidable symbol) in a presentation order of the skill game (step 704). Determining the position of the dragged-to cell can comprise referring to game rules that define positions of each cell 312 and a presentation order in the array of cells 304 for the skill game. The presentation order can define the priority of each position in the array of cells 304. Cells 312 having a higher priority in the presentation order can have a higher chance of winning in a subsequent play while cells 312 having a lower priority in the presentation order, and vice versa.

Next, the method can proceed by determining a symbol type of the particular symbol (step 708). As provided above, when a particular symbol has been dragged from one cell 312 to another cell 312, the symbol type associated with the particular symbol remains the same as when it first appeared. If the symbol type of the particular symbol was a “cherry” when the particular symbol identified as being the slidable symbol appeared, then any movement of the particular symbol (e.g., to another cell 312 in the array of cells 304) will not change the symbol type from the “cherry.” Stated another way, the symbol type for the particular symbol remains the same while it is able to be moved and when it is eventually moved from one cell 312 to another in the array of cells 304. Depending on the rules of the skill game, different symbol types can have different values, in step 708, the symbol type for the particular symbol is determined to ascertain a value of the symbol in the skill game. The value of a symbol in the skill game can affect a payout amount for a winning game outcome (e.g., a winning sequence of symbols). For instance, the higher the value of the symbol, the higher the payout amount and vice versa.

The method can continue by determining odds for a winning game outcome based on the determined symbol type and the determined position of the another, dragged-to, cell (step 712). The odds, or chances, of winning can be based on a combination of the position of the dragged-to cell in the presentation order and the value of the symbol type associated with the particular symbol. For instance, if the symbol type of the particular symbol is determined to have the highest value in the skill game, but the position of the dragged-to cell in the presentation order is associated with the lowest priority, the odds of obtaining a winning game outcome (e.g., a winning sequence of symbols) would be lower than if the same particular symbol was positioned in the cell in the presentation order that is associated with the highest priority.

In some embodiments, the method can determine whether the particular symbol was moved from a cell having a lower priority to a cell having a higher priority (step 716). These priorities can correspond to the priorities of each column 116a-116e described above. Depending on the movement of the particular symbol from a lower priority to a higher priority or from a higher priority to a lower priority, the proposed payout amount for a winning game outcome in a subsequent play can be altered. For instance, if the particular symbol is moved from a lower priority position to a higher priority position in the array of cells 304, the proposed payout amount for a winning game outcome can be decreased, or decremented (step 720).

On the other hand, in embodiments, if the particular symbol is moved from a higher priority position to a lower priority position in the array of cells 304, the proposed payout amount for a winning game outcome can be increased, or incremented (step 724). In this manner, a player can be encouraged to move the particular symbol to a lower priority position as part of the sliding symbol operation to increase a potential payout even though the chances of winning, with the particular symbol in the lower priority position, can decrease.

In addition or alternatively, a player can be encouraged to move the particular symbol to a higher priority position as part of the sliding symbol operation to increase chances of winning even though the potential payout can be lower than if the particular symbol were moved to a lower priority position in the presentation order.

Based on at least one of the proposed payout amount and the determined odds for the winning game outcome, the method can proceed by generating subsequent play information for the next play where the sliding symbol operation is enabled (step 728). In some embodiments, this subsequent play information can be rendered to a pop-up window 504, for example, in a subsequent play information area 506. Examples of the subsequent play information can include, but are in no way limited to, chances of winning with the particular symbol in the dragged-to position, chances of losing with the particular symbol in the dragged-to position, a proposed payout amount should the subsequent play result in a winning sequence of symbols or game outcome, a number of plays where the particular symbol is maintained in the dragged-to position, and/or combinations thereof. The subsequent play information can provide a player with further information to evaluate their chances of winning or losing with associated proposed payout amounts when determining where to drag or slide the particular symbol during a sliding symbol operation. Among other things, this information can assist a player in determining whether to provide a confirmation input and continue playing with the particular symbol oriented in a particular position, or cell 312, of the array of cells 304 or reposition the particular symbol to alter a behavior of the skill game.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure can include: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines (EGM), and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

A central server, central controller, or remote host and an EGM (or personal gaming device) can be configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications can render such technology suitable for some or all communications, particularly if such communications are encrypted. Higher data transmission speeds can be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure can be implemented entirely hardware, entirely software (including firmware, resident software, and/or micro-code) or combining software and hardware implementation that can all generally be referred to herein as a “circuit,” “module,” “component,” or “system.” Furthermore, aspects of the present disclosure can take the form of a computer program product embodied in one or more computer readable media having computer readable program code embodied thereon.

Any combination of one or more computer readable media can be utilized. The computer readable media can be a computer readable signal medium or a computer readable storage medium. A computer readable storage medium can be, for example, but not limited to, an electronic, magnetic, optical, electromagnetic, or semiconductor system, apparatus, or device, or any suitable combination of the foregoing.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device. Program code embodied on a computer readable signal medium can be transmitted using any appropriate medium, including but not limited to wireless, wireline, optical fiber cable, RF, or any suitable combination of the foregoing.

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions can also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions can also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

What is claimed is:

1. A skill-based amusement system, comprising: a display;
at least one player station having player controls configured to control one or more selected actions for play of a skill-based game presented on the display,
a control system in communication with the at least one player station, the control system including a memory and one or more processors configured to execute a plurality of instructions stored in the memory to:
generate a first sequence of a plurality of symbols in a first play on the display screen in response to receiving a first input by a player of the skill-based, amusement system;
render each symbol of the first sequence of the plurality of symbols in a respective cell of an array of cells at the completion of the first play, wherein the first sequence of symbols is rendered such that each cell in the array of cells comprises a discrete symbol type in the first sequence of symbols;
determine at least one slidable symbol in the array of cells that is associated with a sliding symbol operation, wherein the slidable symbol is rendered with an identifying mark that indicates to the player that the slidable symbol can be selectively moved by the player to a new position in the array of cells;
move the slideable symbol from the cell in which it was rendered in the first sequence of a plurality of symbols to a selected cell in the array of cells along an acceptable line of movement in response to input from the player, wherein the discrete symbol type associated with the slidable symbol remains the same;
determine subsequent play information based on the slidable symbol being positioned in the selected cell of the array of cells, wherein the slidable symbol can be selectively repositioned within the array of cells such that subsequent play information is determined for each selected cell in which the slidable symbol is repositioned;
generate a post-confirmation sequence of the plurality of symbols in a second play on the display screen in response to receiving a confirmation of the selected cell position of the slideable symbol in a confirmed position based on the subsequent play information via input from the player;
render each symbol of the post-confirmation sequence of the plurality of symbols in a respective cell of an array of cells at the completion of the post-confirmation play, wherein the post-confirmation sequence of symbols is rendered in the array of cells such that the selected cell position of the slidable symbol is maintained in the confirmed position; and
determine, based on a position of the confirmed position of the selected cell position of the slideable symbol and a position of each symbol in the post-confirmation sequence of symbols relative to a presentation order, a game outcome of the post-confirmation play.

2. The skill-based amusement system of claim 1, wherein the plurality of instructions to determine subsequent play information includes instructions configured to:
determine odds for a winning game outcome based on the determined value of the slidable symbol and the determined position of the selected cell of the slidable symbol in the selected cell of the array of cells;
determine a proposed payout amount based on a change in relative cell priority when the slidable symbol is repositioned to the selected cell; and
generate subsequent play information for a next play based on at least one of the proposed payout amount and the determined odds for the winning game outcome.

3. The skill-based amusement system of claim 2, wherein the plurality of instructions to determine odds for the winning game outcome includes instructions configured to determine the selected cell position of the slideable symbol in relation to a presentation order in the array of cell that defines the priority of each position in the array of cells.

4. The skill-based amusement system of claim 3, wherein the plurality of instructions to determine odds for the winning game outcome includes instructions configured to evaluate the discrete symbol type of the slidable symbol to ascertain a value of the slidable symbol.

5. The skill-based amusement system of claim 2, wherein the proposed payout is evaluated after the slidable symbol is selectively repositioned within the array of cells.

6. The skill-based amusement system of claim 1, wherein the plurality of instructions further includes instructions to determine the game outcome based on an amount of time remaining on a timer.

7. The skill-based amusement system of claim 6, wherein the amount of time remaining on the timer is associated with respective symbols and/or based on the symbol type.

8. The skill-based amusement system of claim 1, wherein the plurality of instructions further includes instructions to provide a visual cue to help the player determine a winning game outcome.

9. The skill-based amusement system of claim 1, wherein the plurality of instructions further includes instructions to continue play by sliding a different slideable symbol from the cell in which it was rendered in the post-confirmation sequence of a plurality of symbols to a selected cell in the array of cells along an acceptable line of movement, wherein the discrete symbol type associated with the different slidable symbol remains the same.

10. The skill-based amusement system of claim 1, wherein the array of cells has a specific presentation order defining a specific position of each cell relative to the other respective cells of the array of cells.

11. The skill-based amusement system of claim 1, wherein the discrete symbol comprises a symbol generated for a cell in the array of cells from a predetermined group of symbols.

12. The skill-based amusement system of claim 1, wherein the predetermined group of symbols includes a symbol corresponding to an absence of a symbol or a blank symbol.

13. A method for operation of a skill-based amusement system, comprising:
generating a first sequence of a plurality of symbols in a first play on a display screen in response to receiving a first input by a player of the skill-based, amusement system;
rendering each symbol of the first sequence of the plurality of symbols in a respective cell of an array of cells at the completion of the first play, wherein the first sequence of symbols is rendered such that each cell in the array of cells comprises a discrete symbol type in the first sequence of symbols;
determining at least one slidable symbol in the array of cells that is associated with a sliding symbol operation, wherein the slidable symbol is rendered with an identifying mark that indicates to the player that the slidable symbol can be selectively moved by the player to a new position in the array of cells;
initiating game play by sliding the slideable symbol from the cell in which it was rendered in the first sequence of a plurality of symbols to a selected cell in the array of cells along an acceptable line of movement, wherein the discrete symbol type associated with the slidable symbol remains the same;
determining subsequent play information based on the slidable symbol being positioned in the selected cell of the array of cells, wherein the slidable symbol is selectively repositioned within the array of cells such that subsequent play information is determined for each selected cell in which the slidable symbol is repositioned;
confirming, based on the subsequent play information, the selected cell position of the slideable symbol in a confirmed position;
generating a post-confirmation sequence of the plurality of symbols in a subsequent play on the display screen in response to receiving the confirmation of the selected cell position of the slideable symbol in the confirmed position;
rendering each symbol of the post-confirmation sequence of the plurality of symbols in a respective cell of an array of cells at the completion of the second play, wherein the post-confirmation sequence of symbols is rendered in the array of cells such that the selected cell position of the slidable symbol is maintained in the confirmed position; and
determining, based on a position of the confirmed position of the selected cell position of the slideable symbol and a position of each symbol in the post-confirmation sequence of symbols relative to a presentation order, a game outcome of the post-confirmation play.

14. The method for operation of a skill-based amusement system of claim 13, wherein the step of determining subsequent play information comprises:
determining odds for a winning game outcome based on the determined value of the slidable symbol and the determined position of the selected cell of the slidable symbol in the selected cell of the array of cells;
determining a proposed payout amount based on a change in relative cell priority when the slidable symbol is repositioned to the selected cell; and
generating subsequent play information for a next play based on at least one of the proposed payout amount and the determined odds for the winning game outcome.

15. The method for operation of a skill-based amusement system of claim 14, wherein the step of determining odds for the winning game outcome comprises determining the selected cell position of the slideable symbol in relation to a presentation order in the array of cell that defines the priority of each position in the array of cells.

16. The method for operation of a skill-based amusement system of claim 15, wherein cells having a higher priority in the presentation order have a higher chance of winning in a subsequent play.

17. The method for operation of a skill-based amusement system of claim 14, wherein the step of determining odds for the proposed payout amount comprises evaluating the discrete symbol type of the slidable symbol to ascertain a value of the slidable symbol.

18. The method for operation of a skill-based amusement system of claim 14, wherein the proposed payout is evaluated after the slidable symbol is selectively repositioned within the array of cells.

19. The method for operation of a skill-based amusement system of claim 13, further comprising determining the game outcome based on an amount of time remaining on a timer.

20. The method for operation of a skill-based amusement system of claim 13, further comprising providing a visual cue to help the play determine a winning game outcome.

21. The method for operation of a skill-based amusement system of claim 13, further comprising continuing play by sliding a different slideable symbol from the cell in which it was rendered in the post-confirmation sequence of a plurality of symbols to a selected cell in the array of cells along an acceptable line of movement, wherein the discrete symbol type associated with the different slidable symbol remains the same.

22. The method for operation of a skill-based amusement system of claim 13, wherein the array of cells has a specific presentation order defining a specific position of each cell relative to the other respective cells of the array of cells.

23. The method for operation of a skill-based amusement system of claim 13, wherein the discrete symbol comprises a symbol generated for a cell in the array of cells from a predetermined group of symbols.

24. The method for operation of a skill-based amusement system of claim 23, wherein the predetermined group of symbols incudes a symbol corresponding to an absence of a symbol or a blank symbol.

25. An amusement system for play of a skill-based game, comprising:
a display adapted to display a playfield; and
one or more processors in communication with at least one memory having stored therein a plurality of instructions executed by the one or more processors for play of the skill-based game to:
generate a first sequence of a plurality of symbols in a first play on the display screen in response to receiving a first input by a player of the skill-based, amusement system;
render each symbol of the first sequence of the plurality of symbols in a respective cell of an array of cells at the completion of the first play, wherein the first sequence of symbols is rendered such that each cell in the array of cells comprises a discrete symbol type in the first sequence of symbols;
determine at least one slidable symbol in the array of cells that is associated with a sliding symbol operation, wherein the slidable symbol is rendered with an identifying mark that indicates to the player that the slidable symbol can be selectively moved by the player to a new position in the array of cells;
move the slideable symbol from the cell in which it was rendered in the first sequence of a plurality of symbols to a selected cell in the array of cells along an acceptable line of movement in response to input from the player, wherein the discrete symbol type associated with the slidable symbol remains the same;
determine subsequent play information based on the slidable symbol being positioned in the selected cell of the array of cells, wherein the slidable symbol can be selectively repositioned within the array of cells such that subsequent play information is determined for each selected cell in which the slidable symbol is repositioned;
generate a post-confirmation sequence of the plurality of symbols in a second play on the display screen in response to receiving a confirmation of the selected cell position of the slideable symbol in a confirmed position based on the subsequent play information via input from the player;
render each symbol of the post-confirmation sequence of the plurality of symbols in a respective cell of an array of cells at the completion of the post-confirmation play, wherein the post-confirmation sequence of symbols is rendered in the array of cells such that the selected cell position of the slidable symbol is maintained in the confirmed position; and
determine, based on a position of the confirmed position of the selected cell position of the slideable symbol and a position of each symbol in the post-confirmation sequence of symbols relative to a presentation order, a game outcome of the post-confirmation play.

26. The amusement system of claim 25, wherein the plurality of instructions to determine subsequent play information includes instructions configured to:
determine odds for a winning game outcome based on the determined value of the slidable symbol and the determined position of the selected cell of the slidable symbol in the selected cell of the array of cells;
determine a proposed payout amount based on a change in relative cell priority when the slidable symbol is repositioned to the selected cell; and
generate subsequent play information for a next play based on at least one of the proposed payout amount and the determined odds for the winning game outcome.

27. The skill-based amusement system of claim 26, wherein the plurality of instructions to determine odds for the winning game outcome includes instructions configured to determine the selected cell position of the slideable symbol in relation to a presentation order in the array of cell that defines the priority of each position in the array of cells.

28. The skill-based amusement system of claim 27, wherein the plurality of instructions to determine odds for the winning game outcome includes instructions configured to evaluate the discrete symbol type of the slidable symbol to ascertain a value of the slidable symbol.

29. The skill-based amusement system of claim 26, wherein the proposed payout is evaluated after the slidable symbol is selectively repositioned within the array of cells.
